(19) United States
(12) Patent Application Publication
(10) Pub. No.: US 2002/0123983 A1
(43) Pub. Date: Sep. 5, 2002

(54) Method for implementing service desk capability

(76) Inventors: Karen E. Riley, Denver, CO (US); William D. McVicker, Fisher A.C.T. (AU); Stephen Nunn, Newbury (GB); Samir Anand, Teddington (GB); John Brett, London (GB)

Correspondence Address: BRINKS HOFER GILSON & LIONE, P.O. BOX 10395, CHICAGO, IL, 60610, US

(21) Appl. No.: 10/029,769

(22) Filed: Oct. 19, 2001

Related U.S. Application Data
(60) Provisional application No. 60/242,007, filed on Oct. 20, 2000.

(51) Int. Cl. G06F 7/00

(52) U.S. Cl. 707/1

(57) ABSTRACT

A service desk capability is accessible by customers of the service desk, the customers including external customers, e-commerce customers, and global customers. The service desk includes means for solving problems and incidents reported, and also means for tracking and reporting the service desk's performance in solving the problems and incidents. A method for providing the service desk capability is also disclosed.

This application claims the benefit under 35 U.S.C. § 119 (e) of U.S. provisional application Ser. No. 60/242,007, filed on Oct. 20, 2000, which is hereby incorporated by reference.

### FIELD OF THE INVENTION

This invention pertains to the field of help desks, and more particularly to the field of reporting and resolving problems and incidents with computer usage by way of a help desk. The invention also pertains to technical support help desks, functional help desks, and call centers for areas other than computers and computer-related functions.

### BACKGROUND INFORMATION

The following patent applications contain information that may be useful in understanding the disclosures of the present invention, and are hereby incorporated in their entirety by reference: U.S. patent application Ser. No. 09/685,162, entitled Organization of Information Technology Functions, filed Oct. 6, 2000; U.S. patent application Ser. No. 09/684,071, entitled Method and Estimator for Providing Change Control, filed Oct. 6, 2000; U.S. patent application Ser. No. 09/684,155, entitled Method and Estimator for Providing Service Level Management, filed Oct. 6, 2000; and U.S. patent application Ser. No. 09/684,353, entitled Method and Estimator for Providing Event/Fault Monitoring, filed Oct. 6, 2000.

### BACKGROUND OF THE INVENTION

Knowledge workers need access to help in performing their daily jobs no less than other workers, such as blue-collar workers, manufacturing workers, or service workers not in a knowledge-management area. Such knowledge workers typically access a computer in their daily tasks, and may need assistance in many forms. This assistance is needed because individuals cannot possess all the knowledge that is generated every day and which may change every day in every field, let alone the knowledge worker's field of specialization.

To help knowledge workers, help desks have been implemented, especially to assist computer users. A help desk may be thought of as a bureau, in the Frederick Taylor or good sense of the word, to which an applicant brings a problem for resolution. In the good sense of the word, a bureau is the proper place to bring an issue or a problem. An expert at the bureau takes the problems in the order they are presented, and works on the problems one at a time. The expert resolves the problem and enables the person presenting the problem to get on with the business at hand. And so it is with a help desk. A caller forgets a password, is unable to solve an application problem, or has some other problem or incident. The help desk takes on the problem, solves the problem, and enables the worker to return to productive work.

This paradigm for a service desk or help desk is sufficient for small organizations and relatively simple issues. However, as computer usage and Internet usage have multiplied and expanded, the simple “help desk” paradigm is insufficient for prompt and efficient resolution of incidents and problems. This issues arises when users are spread across many time zones, perhaps even across the globe, requiring 24 hour coverage, 7 days per week. The issue arises even more so when communication between user and helper occurs through the Internet, such as through e-mail, rather than to a help desk across the hall or across town. Finally, the help desk concept is not helpful to users whose questions are in a functional area other than computer technology or peripherals for computers, such as software or hardware.

What is needed is a help desk or service desk that will be effective for customers or users requiring global reach, for service over the Internet or for e-commerce. What is needed is a help desk for other technology areas or for other functions, such as sales, finance, legal, human resources, and the like, where a knowledge worker can go for assistance with problems and incidents.

### BRIEF SUMMARY OF THE INVENTION

The present invention meets this need by providing a service desk capability that is effective for a great variety of customers. One embodiment of the invention is a method for providing a service desk capability. The 5 method comprises the steps of receiving the request for service, logging the request, and categorizing the request. The method also includes assigning the request for service, and resolving the request. After resolving the request for service, the method includes confirming resolution of the request, and closing the request for service. The service desk capability responds to requests from at least one customer selected from the group consisting of an internal customer, an external customer, a global customer, and an e-commerce customer. The service desk capability or function may help with, but is not limited to, areas of information technology, human resources, finance, engineering, medicine, nursing, procedure, insurance, retail, and legal resources.

Another embodiment of the invention is a service desk for customers selected from the group consisting of internal customers, external customers, global customers and e-commerce customers. The service desk comprises a service desk computer network accessible by customers, and a system for solving problems and incidents reported by customers of the service desk. The service desk also includes a system for confirming resolution of the problems and incidents reported by customers of the service desk. The service desk also includes at least one repository for storing information useful in solving problems and incidents, the repository accessible by the computer network. The service desk organization works to resolve the problems and incidents of its customers. The service desk may help in, but is not limited to, areas of information technology, human resources, finance, engineering, medicine, nursing, procedure, insurance, retail, and legal resources.

### BRIEF DESCRIPTION OF SEVERAL VIEWS OF THE DRAWINGS

FIG. 1 is a block diagram of types of service desks.

FIG. 2 is a block diagram of areas of application for a service desk.

FIG. 3 is a block diagram of an approach for design of a service desk.

FIG. 4 is a flow chart for a method of processing service requests.

FIG. 5 is a flow chart for a method of contacting a service desk.

FIG. 6 is a flow chart for a method of logging and categorizing requests for service.

FIG. 7 is a diagram for a chart of hierarchies.

FIG. 8 is a chart listing examples of impact of an affected process.

FIG. 9 is a flow chart for a process of resolving service requests.

FIG. 10 is a chart of events causing notification of an assignment.

FIG. 11 is a flow chart for a process of assigning service requests.

FIG. 12 is a flow chart for a process of resolving and escalating service requests.

FIG. 13 is a flow chart for a process of confirming resolution of a service request.

FIG. 14 is a flow chart for a process of requesting closure of a request.

FIG. 15 is a flow chart for a process of storing and managing knowledge relevant to service requests.

FIG. 16 is a flow chart for a process of providing service level control.

FIG. 17 is a flow chart for a process of analyzing a problem or an incident for the root cause of the problem or the incident.

FIG. 18 depicts the tiers of a service desk.

FIG. 19 depicts a system for tailoring a service desk function in accordance with the needs of the organization.

### DETAILED DESCRIPTION OF THE PRESENTLY PREFERRED EMBODIMENTS

The Service Desk function focuses on managing internal information technology (“IT”) user service requests and proactively providing relevant information to users and other parties. The ultimate goal is to keep users working as effectively as possible and to allow them to plan around any issues or changes. Service requests can relate to problems (such as PC failure, network problems), user administration requests (such as password reset, location moves) and simple service requests (such as a request for a new mouse, or a functional question regarding an application). Information can be supplied back to end users to manage their expectations and to enable them to plan around both scheduled as well as unexpected downtime, or changes to the IT environment. This can include an information service for scheduled system down time and planned resolution times for unexpected system failure.

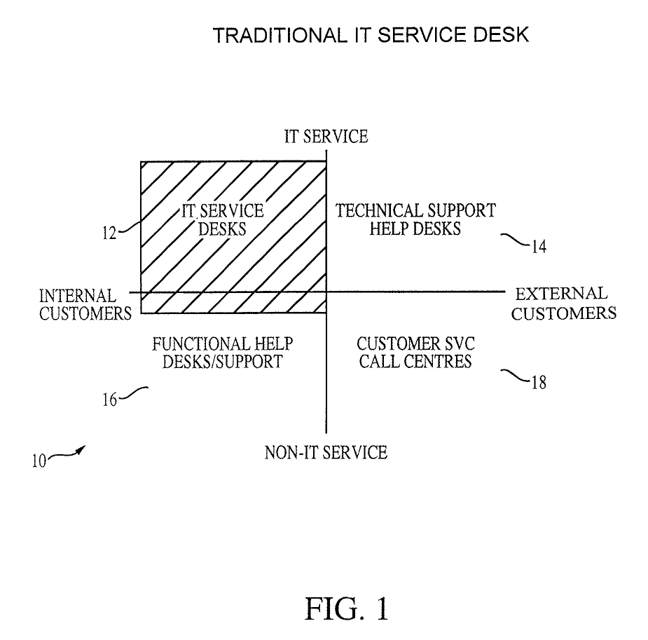

FIG. 1 figuratively represents a complete Service Desk capability 10 and a division of the service desk into four quadrants of service 12, 14, 16, 18. Depending on how the service desk is organized and staffed, it may be internal or external from/to an organization, and the service desk may be organized around only information technology or also around other technical or non-technical areas. One quadrant is a service desk for information technology (IT) services for internal customers of an organization 12. The range of service of such a service desk may be extended by seeking help from other organizations, such as companies offering technical help in computer or IT-related fields 14. Companies seeking such help may be thought of as outsourcing their service desk, or at least a significant portion of it. Companies offering such help are leveraging their resources and building on their core competencies. In addition to an information technology service desk, an organization may also build an internal service desk for other functions 16, such as human resources, finance, legal, and so forth. Finally, the organization may seek to outsource service desk capabilities for these other functions 18. In a way, than, quadrant 18 may be though of as a call center, a source of information for external customers. A company may feel that it does not have sufficient resources for staffing the service desk, including human resources, or that it does not sufficiently utilize its resources, at least not as much as it could.

Service Desk Functions

The Service Desk is the primary operations interface for IT services between the end user and those responsible for IT services provision within an organization. The service desk focuses on managing the IT service requests and providing pro-active feedback to the user communities. The service desk will work within defined Service Level Agreements (SLAs) that set out the services to be performed and the target service levels to be achieved. These SLAs are designed for the user community and are written with the Service Desk customers in mind. The Service Desk will be supported by Operational Level Agreements (OLAs) with the remainder of the IT Service Provision Organization. The service desk function is increasingly integrating with other functions such as Change Management and Asset Management. Service desk tools in the marketplace are being developed to support these functions with interfaces to other functions or other products.

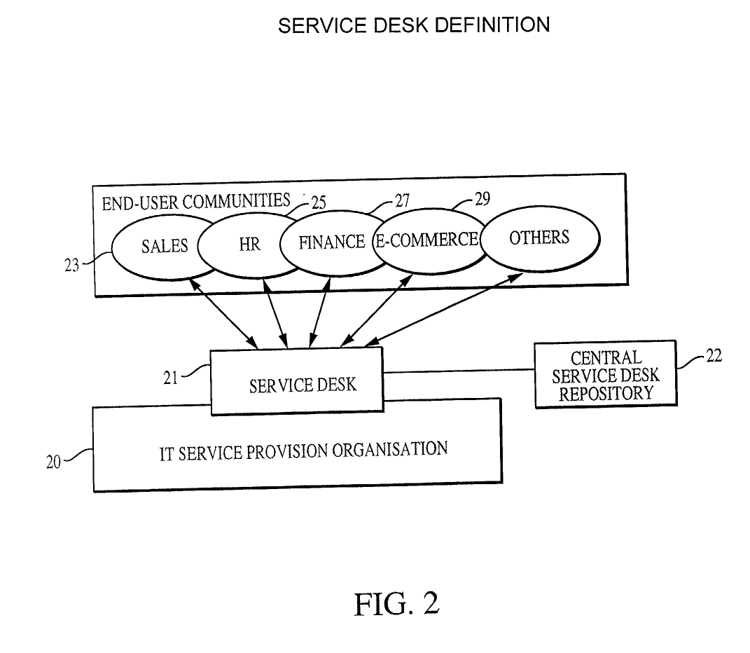

FIG. 2 depicts an organization 20, such as an information technology organization, having a service desk capability 21 that supports customers in a variety of other organizations, including but not limited to, a sales organization 23, a human resources organization 25, a finance organization 27, e-commerce 29, as well as other organizations. The service desk may include a computer network through which customers can access assistance when seeking to resolve a problem or an incident. The service desk may also have a central service desk repository 22, such as a database maintained on a memory storage device, for storing and retrieving problems and solutions for problems, especially repeated and troublesome problems and incidents. FIG. 2 illustrates how various user communities, which can be either part of the same organization, or external to it, access the Service Desk to obtain IT services.

The Service Desk (Service Control function set of the Information Technology (IT) Framework) provides IT customers with a single point of contact for service requests, and provides proactive service, focusing on the overall needs of its IT customers. The typical functions performed by the Service Desk are:

Service Request Management (including Simple Service Requests)

Incident/Problem Management

User Administration.

The Service Desk may also be responsible for other areas of the IT Framework, such as Service Level Management or Event/Fault Monitoring or Management. These definitions include a change in emphasis that enriches the traditional Help Desk function, which focuses on resolving incidents and problems. The Service Desk resolves all simple service requests. Examples of simple service requests include answering functional questions such as “how do I align objects in PowerPoint?”, or “how do I confirm my sales order?”It may also include simple requests for new equipment such as a new LAN cable or mouse. Larger requests can be considered as change requests and be transferred to Change Administration. The definition of what is a “large” request or a “simple” request may be defined by an IT governance function category of the IT Framework. The Problem Management function deals with incidents and problems with the following IT Framework definitions:

An incident is defined as a single occurrence of an issue that affects the user's ability to function in the environment. An incident is defined as an issue that can be resolved using business and product knowledge at the first level of support (by the person answering the call at the Service Desk). A problem is defined as an incident that cannot be resolved at the first level of support and requires additional technical or business expertise. Because it is usually a more complex issue, it may also be the underlying cause of one or more incidents. Experts will correct the problem and its underlying causes(s), while attempting to prevent any recurring incidents. Experts should also provide Level I support with the knowledge required to resolve problems when appropriate.

User administration requests are received through Service Request Management and are assigned to the user administration. User administration handles the tasks involved in administering users on the system, including:

Moving/adding/changing desktops. Handles desktop alterations including moves from location to location and additions and changes to existing desktops. Large department moves or changes are handled by the Project Request Management function set of the IT Framework.

Adding/deleting/modifying users. Receives personnel employment activity information from Human Performance Management regarding employees” hiring, transfers, leaves of absences, and termination.

User documentation and notification. Documents the access levels a user has to the various IT systems and notifies appropriate parties periodically of User Administration status. It includes documenting user account maintenance and goal fulfillment and distributing user account status to the appropriate parties. Parties may include Human Performance Management, Applications Support, and Operations Support, as well as the users.

Maintaining sets of profiles. Maintains the user groups and group profiles. Documents the access levels a user group has to the various IT systems and implements the appropriate changes, including the adding/moving/deleting of users in a group. A user group may be a department or a role that has certain privileges. User groups should be established for employees with similar roles who require the same access level, as it is easier to maintain access levels for a group rather than individually.

Larger application maintenance activities or changes in which numerous users are affected, are typically handled through different functions, either Project Request Management or Change Administration. A governance function set determines how to differentiate between what is a standard User Administration task (a request for two new user IDS) versus a larger User Administration process (30 new user IDs for a new system).

The Service Desk forms part of an organization's strategy to enable end users and business communities to achieve business objectives through the use of technology. Service Desks operate around a number of principles. Although some of these principles will be specific to the organization's objectives, the following aims are common to all organizations:

To continuously improve IT service delivery to end users.

All Service Desk organizations preferably strive to improve the way they deliver services to end users. This requires constant feedback and the monitoring of services provided.

To progress from reactive to proactive end user support.

The Service Desk preferably informs end users of potential problems that are likely to affect them. As the Service Desk is able to monitor and identify potential system problems, it is able to warn users of problems or resolve them before they have a serious impact on users.

To provide an interface to other business functions. The Service Desk is able to identify requirements and needs through day to day interaction with end users. The Service Desk preferably inputs these requirements to other business units, outside the IT organization (for example, training requirements to Personnel).

To provide a link to other IT Framework functions. Service Desk functions form part of the IT Framework functions.

To provide a service solution to meet business problems. 20 In the past, one of the key criticisms of the support for client server technology, has been its inability to deliver what was promised. The Service Desk should understand business issues and the challenges facing its customers. The terminology used by the Service Desk should be familiar to the end users.

Out perform and exceed end user expectations. The key to a successful Service Desk is its ability to manage its end user expectations, and not only meet them but exceed them. Success will be measured by the number of voluntary positive inputs from end users, rather than measured feedback questionnaires.

The Service Desk organization establishes the “people” aspect of the Service Desk. Best practices suggest that an organizational structure should be based on a number of tiers. This allows skills and expertise to be related to the functions performed at each Tier in a cost-effective manner. Those at the lowest tier are responsible for taking calls and resolving problems on-line, while those at more senior levels are involved with monitoring activities and planning. Costs can be controlled by ensuring that expensive staff, with high levels of technical skills, carry out only those functions that are appropriate to their skill levels. Part of the organizational design will require that IT Framework functions for different technology domains are reflected within the Service Desk. Specific groups may be defined within the framework of the Service Desk, for example, the server management group, which will be expected to perform the IT Framework functions for that technology domain. The roles and responsibilities of Service Desk personnel should be clearly defined and related to the IT Framework functional framework across different technology domains.

The Service Desk process should be as automated as possible through the use of enabling technology. Each part of the process may preferably be analyzed to define which parts can be automated and how the integrity of the workflow can be maintained. The goal of implementing technology is to minimize the manual processes involved in running a Service Desk. There are a number of different technology solutions that should be considered, including the telephone system, call and problem management systems, and expert systems and knowledge.

A number of different telephony systems can be used to enhance the functions of the Service Desk. Call and problem management systems form the basis for managing service requests and how these are tracked and escalated. They will normally have interfaces to other tools allowing system faults to automatically generate trouble Tickets and obtain inputs from configuration and asset management databases. The process flows designed to support the Service Desk could be incorporated in an automated workflow solution to ensure that the processes are performed efficiently. Expert systems/knowledge tools systems allow experts to store knowledge in a knowledge database and make such knowledge available when needed to non-experts.

Service Desk Design Approach

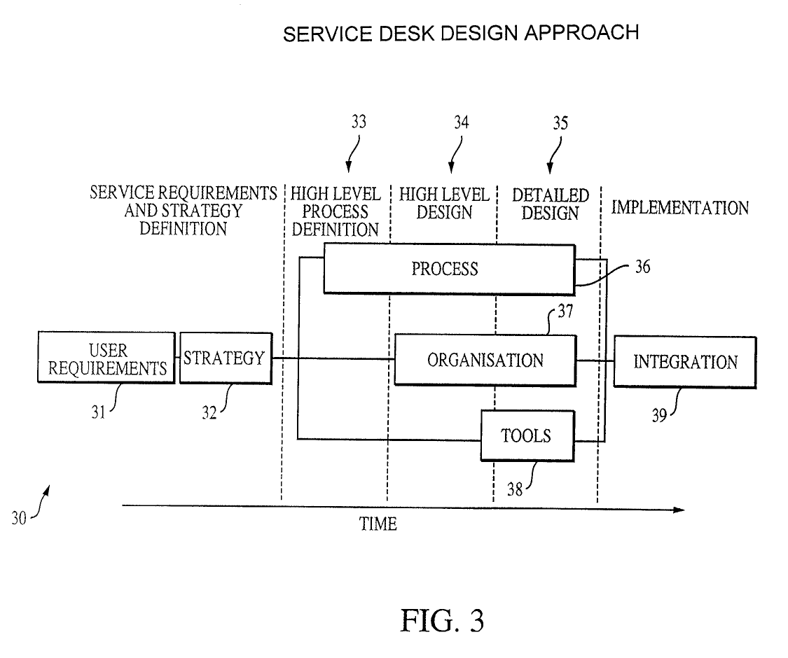

FIG. 3 is a flowchart for a process 30 for designing a service desk. A designer first determines user requirements 31 and defines a strategy for service desk operation 32. The designer then may design and organize for the service desk function using three levels of design, defining a high level process definition 33, then designing the processes themselves in a high level of design 34, followed by detailed design 35. The three states may apply to the process to be used in operating the service desk 36, the organization to operate the service desk 37, and the tools to be used in operating the service desk 38. The last stage of the process is to implement or integrate 39 the completed designs for the process 36, the organization 37, and the tools 38, into a unified whole service desk process. Each process or method used in implementing the service desk may also be considered a system for contributing to some aspect of resolving a problem or an incident.

The purpose of determining service requirements and defining a strategy is to determine the characteristics of the user community and the technical environment in which this community is operating. This information is then used to work out how the Service Desk should be structured to best support the user community. When this has been accomplished, a strategy for the operation of the Service Desk can be developed. This stage may form part of a larger overall program. This could be an IT Transformation or Service Management program. The overall strategy and organization of the IT department may be completed before the more detailed Service Desk project.

The starting point in the development of a Service Desk should be an assessment of the user community to be supported. This assessment should include business functions performed, people of the organization, technology and Service Level Agreements (SLAs). The information gathered will be a primary factor in decisions about Service Desk design. This information can be collected by communicating with users through interviews and surveys.

An assessment of the business functions that groups of users perform should result in descriptions of these functions, outlining how they contribute to the business, as well as the criticality of the function to the business. The user community's level of technical knowledge will help drive the skill requirements of the Service Desk resources. Incidents reported by technical users will tend to be more complex and consequently demand more knowledgeable support resources. The physical location of the user community will be a factor in determining the degree of centralization of the Service Desk. This will help to determine where Service Desk skills will need to be located, and the level of skill required in each location.

The applications and equipment used by the user community, and the infrastructure required for their support may preferably also be assessed. Determining the nature of the technical environment will help to establish the skill sets and tools that will be required to effectively support the user community. The technical environment will comprise elements that can be divided into two categories:

Those visible to the user community - applications and equipment

Those invisible to the user community - infrastructure.

Those components with which users come into direct contact, and will be able to describe, are the applications and equipment that they use to perform their various business functions. These include packaged and custom applications, e-mail, Internet applications, operating systems, printers, voice mail, and telephones, as well as file sharing and printing facilities provided by network operating systems. The criticality of each of these items in assisting users to perform business functions should be assessed.

When user applications and equipment have been identified, the components that are typically invisible to the user are preferably assessed. These include computer network facilities—routers, hubs, gateways, telecommunications circuits, and PABXs—and other facilities used by applications such as servers and databases. These two sets of information help in the prioritization of incidents and requests as well as in determining the types and levels of skill that will be required to staff the Service Desk. Any existing SLAs for services to be covered by the Service Desk will create expectations within the user community about the delivery of those services, and should be taken into account. In addition, any work underway to define SLAs may also affect the Service Desk and should be understood.

It is important to study existing structures within the organization, such as current service desks (if any), current processes, current call types and call routines, current customer set, current key performance indicators (KPIs), current cost of operation, and current tools. Acquiring and understanding this information will help in defining a more precise gap analysis, planning development (including transition), and developing a better value proposition.

Next, a strategy phase uses the information gathered in the User Requirements phase to set the strategy for the operation of the Service Desk, in terms of defining how the Service Desk will assist users in performing their business functions. Deliverables will include a mission and vision statement for the Service Desk. When determining the strategic direction of the Service Desk, the vision, mission, and goals of the team are preferably determined, in that order. These tie into the vision, mission, and goals of the company to ensure that the services being provided are adding value. Additionally, SLAs need to be developed with the customers.

High-level process design comprises effort in three interdependent areas, Service Desk Processes, Service Desk Organization, Service Desk Tools. This phase involves the creation of high-level or outline procedures that detail the tasks to be carried out to accomplish each step within the identified processes and functions. As the tools and organizational structure for the Service Desk are identified these processes should be revised to reflect organizational and tool constraints. The outline procedures created in this phase should include, as a minimum, service request logging, prioritization, assignment and escalation, involvement of external vendors, tracking, and interfaces to other organizations.

Organizational design or definition begins in the high-level design phase by focusing on four inter-linked areas:

Location of Service Desk functions

Effort required to perform Service Desk functions

Roles and responsibilities of Service Desk personnel

Skill requirements of Service Desk personnel

Not only are these areas highly dependent on one other, but decisions made in terms of the processes that the Service Desk preferably follow, and the level of tool support to be made available, will significantly affect the final organization. Indeed, the level of detail for these four areas should be constrained by what is known about tool capabilities, and the level of detail of the procedure definitions.

Identifying tools for the service desk is the third important task of high-level design. Prior to the selection of specific tools for the service desk, the processes and functions for which tool support is required or appropriate are defined. Many tools are currently available that can assist in the performance of various Service Desk functions:

Managing calls - Automatic Call Distribution (ACD) and phone menu systems allow calls to be routed to the appropriate systems and so to available Service Desk personnel. This reduces the amount of time that users wait before receiving support.

Logging and tracking service requests - These tools assist Service Desk personnel in logging service requests: reminding personnel when to escalate incidents, when to provide status information to users, and when service levels are not being met.

Expert systems/knowledge tools - A common feature available with many Service Desk tools is Case Based Reasoning (CBR). These tools allow Service Desk personnel to store information about incidents and the steps required to solve them. If the incidents reoccur, Service Desk personnel can refer to this tool to quickly determine a course of action to resolve the problem.

Reporting - Reporting tools enable Service Desk managers to assess the level of service that is being provided by the Service Desk. These tools are usually integrated with the logging and tracking tools. Reporting tools may also be used to create reports that are distributed to customers. What to report should be determined by the goals and SLAs of the Service Desk.

Web-enabled applications - Increasingly common are web-enabled Service Desk tools to allow customers to service themselves, for example, log Tickets and gain access to knowledge products.

After high level design, a detailed design phase involves the final design of the organization and processes as well as the final selection of tools to be used in the Service Desk. At the end of this phase, the organization (including the roles and responsibilities of personnel), and the procedures for using tools and performing Service Desk tasks, should be finalized. As tools and organizational structure are finalized, processes are detailed to reflect the capabilities of tools and personnel. In addition, procedures for executing Service Desk functions are finalized and documented, and integration with other organizations performing IT Framework functions is finalized and detailed. Aspects of the organization and tools that could affect the defined processes include the level of automation provided by tools and the level of integration with other IT Framework functions. Each procedure or process defined by the detailed design phase may be considered a system in itself, as described below. Thus, a service request process is also a rule-based system for processing service requests.

Generally, the level of automation desirable for Service Desk system implementation depends on the client's background and the target service level. For clients who have no experience with Service Desk procedures, it may sometimes be useful to implement a transitional manual solution. Advanced knowledge technologies are more appropriate for clients who have had successful experience in the use of other less sophisticated tools.

In most cases the final solution includes some level of automation, due to the frequency with which some tasks are performed and the volumes of data managed. The most common and generally appropriate option is to select a call-tracking database tool, and then customize it to comply with the desired requirements to ease Service Desk procedures (such as escalation, assignment, and prioritization). Auxiliary tools include an appropriate phone system to distribute calls, and can also incorporate e-mail, if this option is considered to be worth the additional effort that it represents.

In order to work effectively with other organizations delivering IT Framework functionality, some data sharing is required. The Service Desk should actively market itself within a company to demonstrate its value and therefore should not be viewed as a cost center and/or a team in which no one wants to work.

An Organization Design phase involves finalizing the headcount and responsibilities of Service Desk personnel, with tools and procedures providing input to the final organization design. In particular, responsibility should be clear for the operation of each Service Desk procedure. Typically, a gap analysis should be performed to refine training requirements, headcount, roles and responsibilities, motivation and incentives, career path within the team, and the organizational structure of the team. Once this is accomplished, appropriate training and recruitment programs can be arranged.

A tool selection stage involves the evaluation and selection of tools to support those functions identified earlier as requiring, or suited to, tool support. The evaluation will assess the technological as well as the functional capabilities of particular tools in relation to the Service Desk's requirements.

Developments in process or organization design are also preferably considered.

Prior to full-scale implementation and rollout of the Service Desk, its organization, processes, and tools should be piloted, and any necessary refinements should be made over a pre-defined and fixed time frame. Communication is crucial to help the potential customers of the Service Desk understand what services the Service Desk will be providing, how and when to contact the Service Desk, turnaround times, and so forth. In particular, emphasis is preferably placed on the tools to be used by the Service Desk, ensuring that customization of tool functionality is complete and consistent with defined processes and organizational interfaces.

Service Desk Processes

This section provides details of the process and data flow required to support the functions of the Service Desk identified above. The high-level Service Desk process flow is presented together with detailed descriptions and process steps. In addition to these functions, it is likely that the Service Desk will also cover additional IT Framework functions. Some of the more common additional functions are described together with key interfaces between the functions.

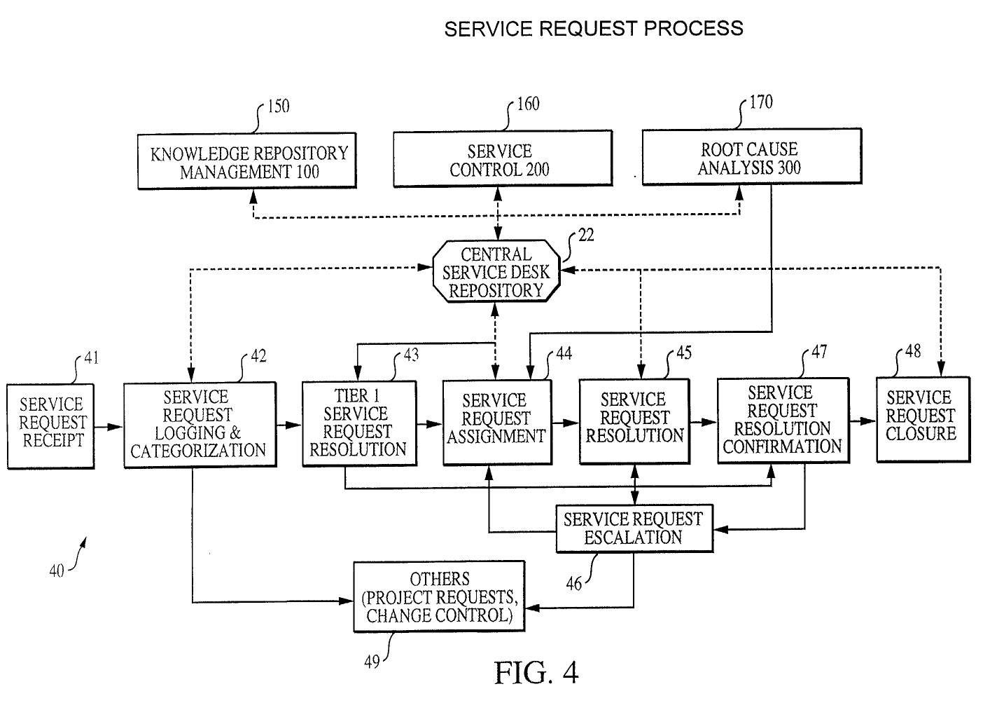

FIG. 4 below shows the high-level process steps for a “green-field site” Service Desk. It might be that there is an existing Service Desk with existing processes that should be analyzed and re-engineered. The figure shows both the high-level process flow and the data information flow between different support levels, and the Service Desk tools (logging, tracking) combined in the Service Desk Repository. Depending on the Service Desk tool selected the Service Desk Repository will consist of one or more databases. The high-level service request process is applicable for simple service requests, incidents and problems, and user administration requests.

In particular, FIG. 4 is a flow chart for a method 40 of processing service requests. A user generates a service request 41, contacting the service desk personnel. The service desk personnel or automatic processes log and categorize the request 42. A service desk operator, Tier 1 personnel, may attempt to resolve the problem 43, possibly by checking for solutions in a central service desk repository or database 22. If the Tier 1 personnel cannot resolve the user's request or problem on the spot, the request may be placed into a queue for assignment 44. The person assigned to the problem (assignee) then attempts to resolve the problem 45, possibly with assistance from the service desk knowledge repository 22 or other resources available to the assignee.

If the assignee is unable to resolve the problem, it may be necessary to escalate the problem via a service request escalation 46 to a higher tier assignee. The escalation request is placed back into the queue for service assignment requests 44, this time for a higher-level assignee. This assignee then repeats the process, attempting to resolve the problem 45. If the assignee is able to solve the problem, it is then necessary to confirm with the user 47 that the problem has indeed been resolved to the user's satisfaction. If the problem is not resolved to the satisfaction of the assignee or the user, it may be necessary to again escalate the service request 46. If the user is satisfied, then the assignee moves to close the service request 48. Change Management and some other functions may be interfaced through the “Other” sub process flow 49.

Lessons learned or other valuable tips or knowledge may be stored in the service desk repository 22 or other database for future use. Reports or statistics may be gathered as part of the service request closure. As outlined elsewhere, these statistics may include performance or other metrics useful for the service desk or the organization employing the service desk. Such metrics may include the clock or calendar time from request to resolution confirmation, resources expended, and the like. Other reports may also be crafted from a compilation of request closures, e.g., number of times a user requests help, number of times a program or application requires assistance, and the like.

The normal method of communication with a service desk is by phone. Other technologies can also be used to ensure convenience to the IT customers. These may include Internet/Intranet access, e-mail or fax. Event Management tools may also be integrated with the service desk. These can be configured to automatically log tickets when faults occur in the IT systems. Examples would include a network failure or direct interfaces to applications).

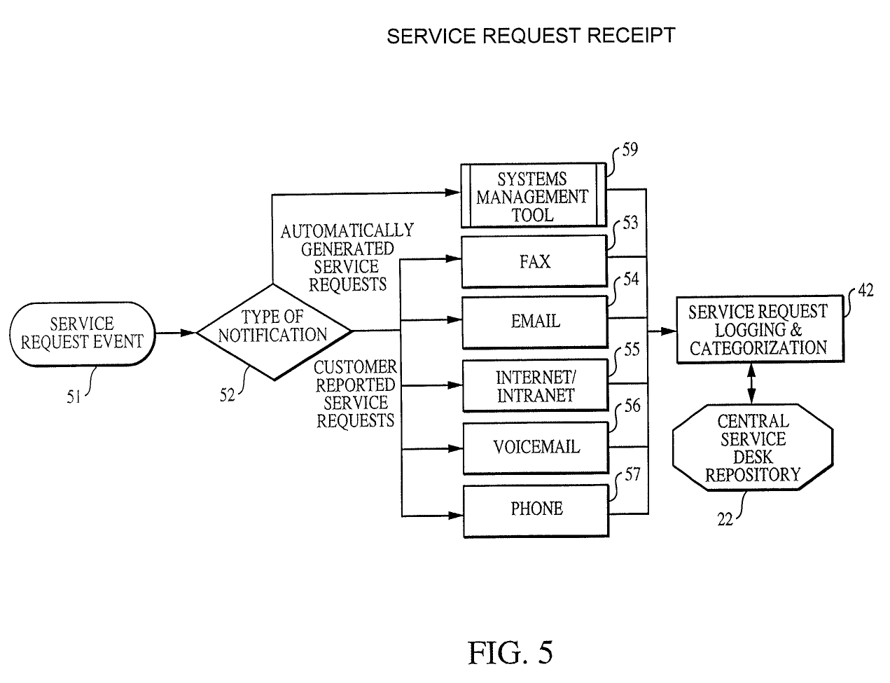

FIG. 5 is a process for a method of contacting a service desk 41. A user experiences an event for which help is needed 51, such as a problem or an incident. The user notifies the service desk 52, by one or more customer reported service request methods, including a facsimile message 53, an e-mail 54, an Internet or Intranet message 55, a voicemail message 56 or a phone call 57 to an operator of the service desk. The service desk may be equipped with a systems management tool 59 to automatically generate service desk requests upon certain events or faults, such as system-wide failures or outages. Reports generated or data collected may be stored in a central service desk repository 22.

An important issue to be considered in this process is Service Desk availability. The primary objective of the Service Desk should be to provide access to core functions throughout the user timetable. The following issues should not be overlooked:

The Service Desk staff responsible for receiving calls could change at different times. See “Service Desk Timetable and Shifts”.

A secondary mechanism of a call registration service should be provided outside the normal user timetable (for example, answer-phone system, e-mail, or voice box).

Outside working hours, calls could be diverted to another organization group (for example, Operations).

This stage of the Service Desk process should make good use of telephony systems that can enhance the processing of a call both before and as it reaches the service desk. These systems can, for example, be used to inform users (service desk customers) of known problems when they call in to the service desk. In the event of a major system outage (for example network failure, primary server failure) the telephone system can first introduce a brief message informing the service desk customers of the problem and expected resolution time. This can help to significantly reduce the number of incidents logged and also manage customer expectations.

Another example would be the use of Voice Response Units (VRUs) in combination with Automated Call Distribution (ACD). This could be used to interactively pre-select service requests, answering some requests without human intervention, or to direct the calls to the appropriate service desk personnel. Knowledge databases can also be made available to end users. This can enable users to interrogate knowledge accumulated at the service desk and possibly enable immediately resolution. It may be useful to monitor the access to these databases to support their use and benefits.

Service Desk operators may manually log service requests due to calls received, or calls may also be logged automatically by Event Management. All service requests (either automatic or manual) should be assigned a unique identification number or Ticket ID. For manual service requests, this number is given to the service desk customer for future reference and tracking purposes. The system should automatically provide information such as date, time and Ticket ID.

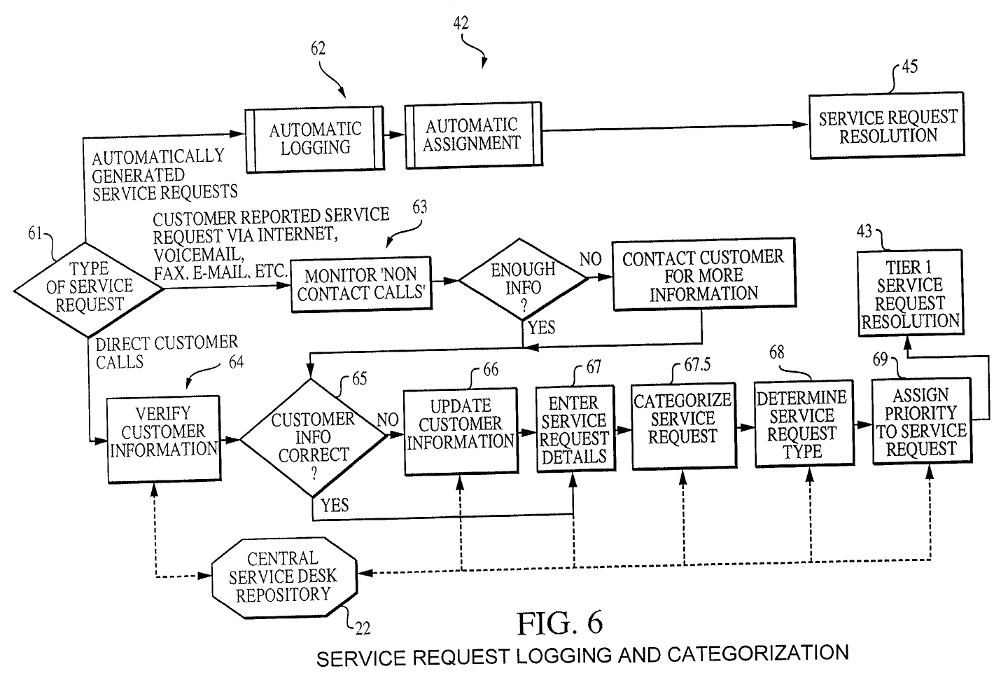

FIG. 6 is a flow chart for a method 42 of logging and categorizing requests for service. The type of request is noted and recorded 61. If the request is one that was automatically logged, then process 62 is followed, in which the request is automatically logged and assigned, and sent to queue for service request resolution 45. If the request was custom-reported via an indirect means, such as by a facsimile, a voice-mail request, an e-mail or Internet/Intranet message, process 63 is followed. A note is made as to whether the service request was aborted or abandoned, and an operator notes whether there is sufficient information to discern the nature of the problem. If there is sufficient information, the request is put into a queue to gather more information from the customer or to verify the information from the customer. The process then proceeds similarly to process 65.

If the service request was made via a direct, completed customer call, then a different process may be followed. The customer information is verified 64 and a decision is made 65 as to whether the information is correct or not. if an update is needed concerning a number of items, an update is made 66. This information may include a number of data, such as the caller's location, contact details, platform type or serial number, his or her operating system and other loaded applications, and the like. If needed, the information can be gathered or stored in a central service desk repository 22. After the customer information is verified or updated, an operator enters details concerning the customer's problem or incident into the service request log 67. The service request is then categorized 67.5, and the type of service requested is determined 68. A priority is then assigned to the request 69. Lastly, the request is sent for first tier request resolution 43.

The following special considerations apply to information collection. Apart from those that are input automatically, normally only service desk operators should be able to log service requests. This may include Tier 1, 2 and 3 support. Depending on tool availability, it may be desirable to allow personnel from other specialized areas to record service requests, such as operations. If more than one user calls regarding the same problem (as would happen with, for example, a network problem) an incident can be opened for each user. All such incidents should be associated with the same problem. Many tools support this technique, and ensure that all incident tickets are automatically closed when the single “parent” problem ticket is closed. If the support tool is not available at the time a call is received, the incident should be manually recorded on paper for later input. Care should be taken to ensure that this record comprises the same information (in the same format) as that requested by the system. This is normally achieved by the design of pre-prepared forms.

The service desk customer should be required to provide (or assist) with the following information: name, location and contact details of service desk customer, description of request and initial categorization (see below), and assets and/or asset types affected. Where calls were received by e-mail, or other indirect mechanisms, it may be necessary to call back and confirm with the Service Desk customer. The process flow above also highlights the need to check and update customer information in the Central Service Desk Repository. This information may become out of date as customers move location, change contact information, or change PCs. Continually checking these details ensures that the repository remains up to date.

Service Request Categorization is a key element of modern Service Desks tools and is often the key to many of the published benefits of these tools. Categorization can be used either manually or automatically to determine the correct person or group to assign or escalate service requests. Categorization may also enable effective trend analysis such as an increasing number of a particular category of issue (for example, an increase in MS Word issues could indicate a failure in the training program of new staff). In addition, it may provide a starting point for many knowledge tool mechanisms. Lastly, categorization may provide cause and effect analysis, by categorizing at Service Request Logging and correcting at Service Request Closure.

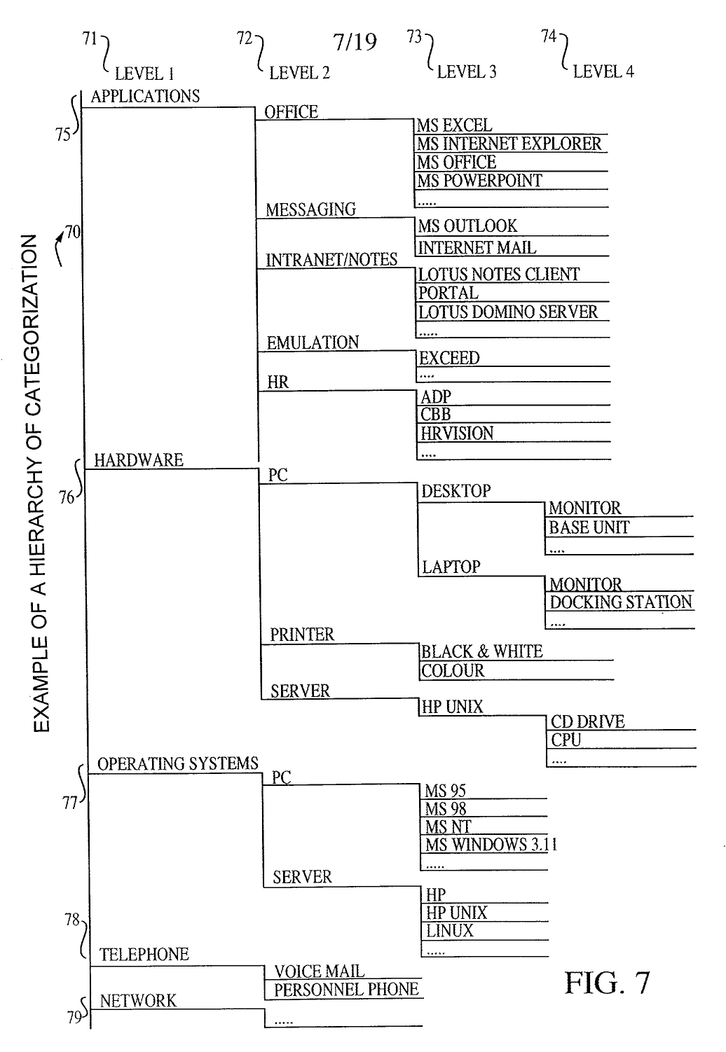

Modern Service Desk tools will often provide a mechanism to provide a hierarchy of categorization. An issue may be categorized as Network/LAN /Router or Hardware/Server/HP UNIX/disk. To be effective this hierarchy should be intuitive. When logging a problem the Service Desk operator may not know the full categorization, but as much detail as necessary can be added down the hierarchy. For most organizations, a 3 or 4 level hierarchy is sufficient although more levels (5 or 6) may be required for some level 3 operations (such as application maintenance). An example of some of the initial values that might make up the hierarchy is provided in FIG. 7 below.

The categorization may also be wrong when first logged, for example what was at first thought to be a Hardware /PC/Desktop/Memory problem may finally be identified as a Network/LAN/Hub problem. This may be due to a number of reasons, such as inexperienced Tier 1 staff, training problems, or an existing problem becoming visible in a new way. When a service request is resolved, the “correct” categorization should always be known in detail (by definition). Some Service Desk tools will allow a “before” and “after” categorization. These cause and effect details can prove useful for analysis and may be used by some of the knowledge-based systems. Knowledge tools may need to be adapted so that they respond not only to the expert defined cause categorization, but also to some of the more regular effect categorizations (for whatever reason these occur).

FIG. 7 is an example of a chart of Service Request Categorization hierarchies 70. Service request hierarchies are not meant to substitute for priorities, but rather are a tool used to categorize the types of problems that service desk operators and experts may face. In this example, for an information technology service desk, there are up to four levels, Level one 71, Level two 72, Level three 73, and Level four 74, for problems or incidents involving five types of assets. These asset types include applications (software) 75, hardware 76, operating systems 77, telephony 78, and at least one network 79.

Development of the correct service request categorization hierarchy is a time consuming task and requires acceptance by all levels of support during detailed design. To be effective the categorization hierarchy is preferably fully understood by all those involved in the Service Desk tiers. If this is not the case then issues will be incorrectly categorized leading to a failure of the four benefits highlighted above.

During the “Service Request Type” process step 68, the Service Desk Operator will attempt to determine the type of service request that is being logged. This is based on the IT Framework functions supported by the Service Desk and therefore in the examples above the type could be marked (flagged) as a simple service request, an incident or a problem, or a user administration request. If the operator believes that the request is a Change Request, it is handled by a Change Control IT Framework function set. There may also be other types of service requests defined, for example it may be desirable to distinguish a “General Query” category.

In the “Assign Priority to Service Request” process step 69, the operator analyzes the service request in order to prioritize it. The resulting prioritization is used to classify the request against all other requests made by the Service Desk customers and determines the speed in which the service request should be handled (according to defined Service Level Agreements or SLAs). An effective process for assigning priority to a service request should be identified. The type of information necessary for assigning priority can include:

The service request's impact

The service request's severity

The criticality of the business function affected

The resolution urgency

The meaning of each of these terms will be adjusted to fit the organization, but each should be clearly defined and documented. Some time should be spent in obtaining agreement with user groups and business units as to the operation of this prioritization process. Whatever the final definition and process it is important that measuring the value of each metric should not take more than a few seconds for a Service Desk operator. The final priority value can then be calculated as required.

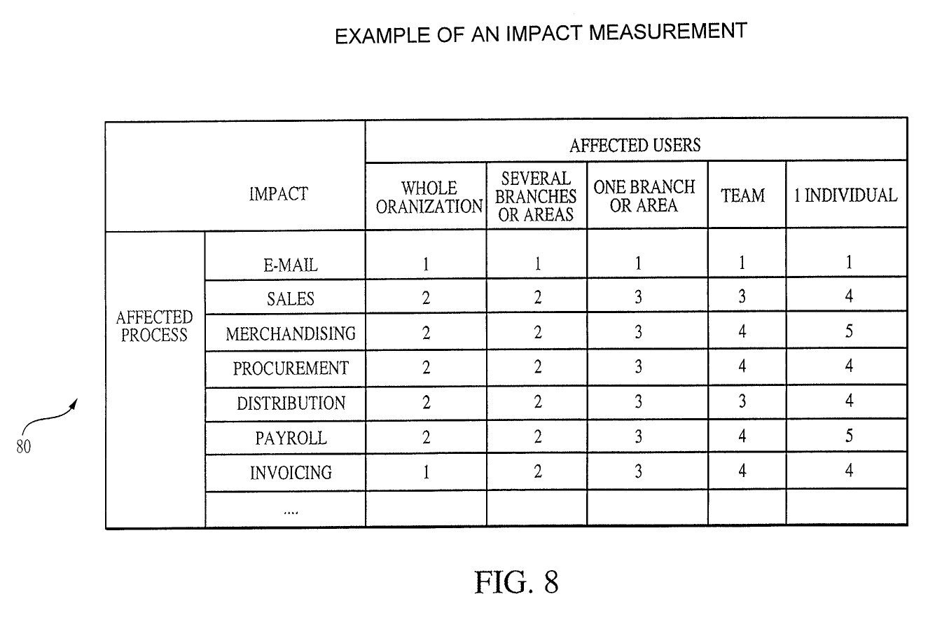

FIG. 8 is a chart 80 listing examples of impact of an affected process. The numbers on the chart are numerals from 1 to 5 reflecting the severity of the impact, with “1” representing maximal impact and “5” representing minimal impact. Impact is a measure of how an incident affects the organization and user group. Impact is usually determined by considering the number of affected users (Service Desk customers) and the affected processes.

The criteria for determining the impact of these two factors may change, but should be clearly and previously defined. Severity can be used to identify those service requests that affect critical processes. This metric can be a flag only: 1 or 0. Its value will be 1 if the affected process is within a list of identified critical processes (for example, periodic accounting data loads). Criticality can be marked as either critical or not (1 or 0) depending on the person that reported the incident (for example, President or Manager). Another possible measure of criticality is the incident's effect on the users, for example:

Critical condition: unable to work

Severe impact: alternatives available (work-around)

Restricted condition: degraded operation

Low impact

Urgency can be used to determine whether an immediate solution is requested or not.

During or after the logging and categorization process, an attempt is made to resolve the service request immediately. Any set of support tools should provide facilities to assist immediate incident resolution, for example:

Problem checklists that help to identify common problems

Lists of error messages and probable causes

Search facilities that enable the operator to find similar problems already recorded in the system

Knowledge database systems (if available)

Basic auxiliary tools such as remote access and diagnosis facilities

If immediate incident resolution is possible, then it is confirmed with the user (Service Request Confirmation), the solution is recorded, and the service request is closed (Service Request Closure).

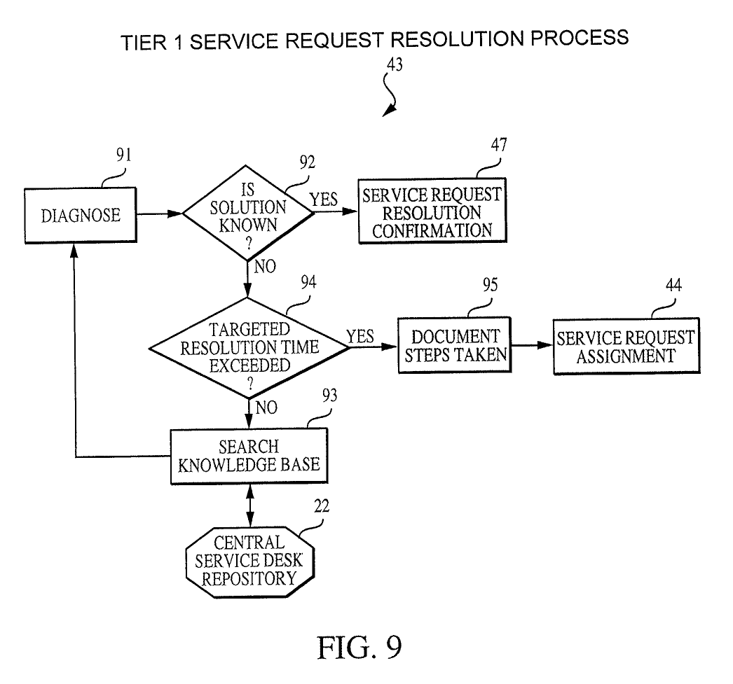

FIG. 9 is a process for resolving service requests by a first tier operator. A first tier operator attempts to diagnose the service request 91. If the solution is known 92, the operator proceeds to implement the solution and resolve and confirm the resolution 47. If the solution is not known, the first tier operator searches 93 a knowledge base, perhaps a central service desk repository 22 for a solution. Again, if the operator finds the solution, he or she then implements the solution, resolve the problem, and confirm the resolution 47. If the solution is still not known after a first search, the operator should check whether the target time to resolve the problem has been exceeded 94. Target times may come from service level agreements or operating level agreements, in which a service provider contracts to provide service up to a certain level, such as to resolve all problems within a certain length of time. If the agreed-upon time, or a target time has been exceeded, the Tier 1 operator may then document the steps taken 95, and request assignment of the problem to a higher tier operator 44. Even if the service desk operator can immediately resolve a service request, the operator should complete mandatory information about the call, such as priority and category.

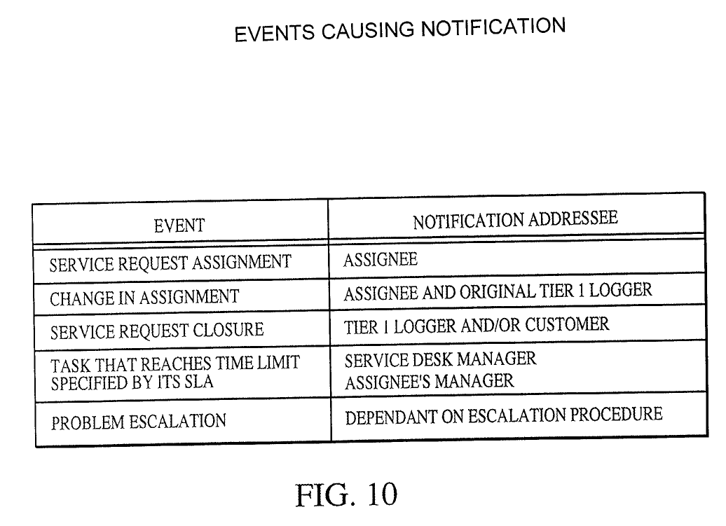

An assignment to a high level is made through a notification. Automatic notification may happen in a number of ways, such as e-mail, pager, or service desk tool-set applications, such as a pop-up window delivered to Tier 2 or Tier 3 personnel. The type of notification used may vary depending on the type of event, the role of the person being notified, and the time of day. For example, priority 1 service requests, with a categorization involving batch systems raised between 4 p.m. and 10 a.m., may automatically notify support staff using a pager. Many other events will also warrant some form of notification. The following table illustrates the most common of these events and the role to which the notification should be addressed. FIG. 10 is a chart of events causing notification of an assignment. Since as assignment is made through notification, more than one party (the assignee) may be notified. FIG. 10 suggests which person to notify.

If the first level of the service desk cannot resolve the request on-line as part of Tier 1 Attempted Resolution, then it is assigned to Tier 2. In line with IT Framework terminology, if the service request is of type “Incident,” then when the service request is assigned to Tier 2 or 3 it becomes a “Problem,” by definition. Once the priority and assignment of a service request have been decided, the Tier 1 operator then decides the correct resource to assign the service request. This person (assignee) is then notified, either automatically by the tool-set, or by the individual making the assignment if the priority is high.

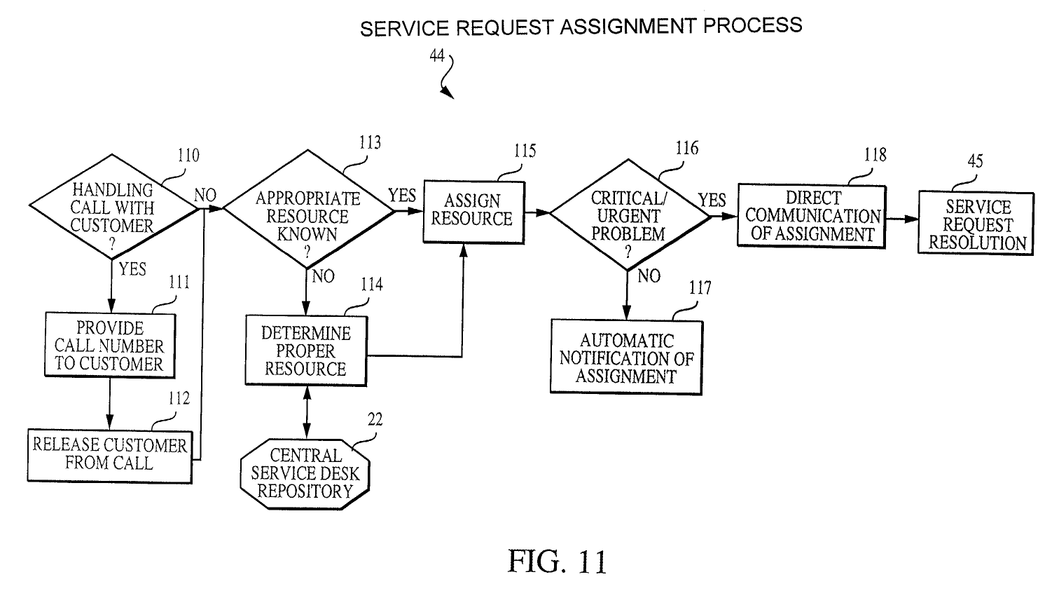

FIG. 11 is a flowchart for a process 44 of assigning service requests if a service desk operator cannot handle the call on-line. The operator begins by deciding whether the operator can handle the call from a customer 90. If the operator can handle the call, he or she may provide a call number (such as a request number or ticket number) to the customer 111 and then release the customer from the call 1 12. If the operator cannot solve the customer's problem, the service desk operator tries to determine the appropriate resource to solve the problem 113. If the resource is known, the operator assigns the resource 115. If the resource is not known, the operator determines the proper resource 114, perhaps with reference to a central service desk knowledge or resource repository 22, and then assign the resource 115. If the problem is urgent 116, the operator may facilitate the assignment. The operator may facilitate by seeking assistance or directly notifying the resource or “assignee” 118. If the problem is not urgent, notification of the assignee may occur through normal, automatic assignment processes 117. The resource or “assignee” then proceeds to resolve the service request 45.

The assignee analyses the service request and tries to find a solution. The assignee may have access to support tools such as a modem or specific software through LAN/WAN for remote connection, remote operation software, or production version software (but not necessarily the production environment). If a solution is not found within the time specified in the SLA, the service request is escalated. Escalation can be performed manually or automatically. Usually, a tracking tool enables a target resolution time to be specified (as defined in the SLA) depending on priority. If that time is overrun an event is produced that notifies the Service Desk manager. Escalation will make use of the notification methods (see above).

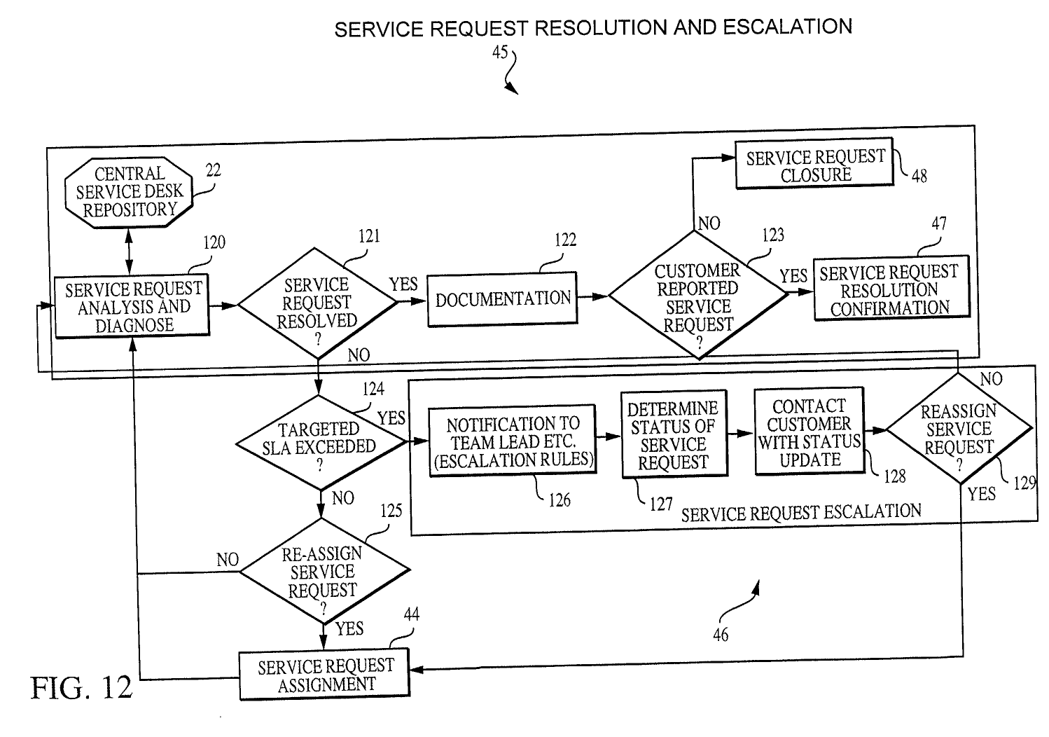

FIG. 12 is a flow chart for a process of resolving 45 and if necessary, escalating 46 service requests to a higher Tier. The process begins with a request by a lower tier operator for a service request assignment 44 to a higher tier or to an “assignee” in a higher tier. The assignee analyzes and diagnoses the service request 120, perhaps seeking information from a service desk repository of information 22. If the assignee is able to resolve the service request 121, he or she may then document the solution 122. If the request was customer-generated 123, the assignee may then seek confirmation of resolution from the customer 47. If the request was not customer-generated (such as when a request is automatically generated by 30 certain events or faults), may then move to close the service request 48.

However, if the assignee is not able to quickly resolve the service request 121, he or she may check whether the request has exceeded the service level agreement that the service desk agreed to provide 124. If the agree-upon level has not been exceeded, the assignee may seek to reassign the request 125 or try again, perhaps beginning with the step of analyzing and diagnosing the service request 120. If the level has been exceed, the assignee may seek escalation through the escalation process 46. The assignee may then proceed through steps of appropriate notification 126, and other procedures agreed upon for escalation. These procedures may include determining the status of the service request and any documentation that is appropriate 127. The assignee may also notify the requester (user, customer) of the status of the request 128. If the assignee decides to escalate and reassign 129, the request then enters a queue for reassignment 44. If the assignee decides to try again, or if a decision is made that he or she should try again, he or she may repeat the process, beginning with a fresh analysis and diagnosis of the problem 120.

The two steps of problem resolution and problem escalation are closely linked. As soon as a problem cannot be resolved in the targeted service levels, it will be escalated and goes back to problem resolution. A problem can be escalated several times. Within problem escalation, the status of the problem should always be determined and the user informed. Service requests are escalated if SLAs are likely to be impacted. The escalation should be configured to occur well before the actual SLA targets are passed, as this can provide an opportunity to still get the service request completed within the SLA. The detailed escalation procedures can be very different depending on Service Desk organization, size, type of service requests handled, and so on. Escalation usually includes the notification of the assignee and the next level of management. Problems may continue to be escalated up to the levels of service control. The Service Request Escalation process has been combined with the Service Request Resolution process in FIG. 12 above.

As service requests are escalated, the Service Desk needs to communicate the status with the customer on a regular basis and update the status constantly with the tracking tool. SLAs should be defined end-to-end, from the time the customer calls in the service request to the time they confirm the resolution was correct, rather than time spent at Tier 1 and time spent at Tier 2, and so on. The escalation rules can help to ensure that the Service Desk focuses on these end-to-end SLAs. “Internal SLAs” or OLAs can be used to measure time at Tier 1, Tier 2, and so on.

Before a service request can be marked as ‘closed’, affected users are notified and consulted to ensure they are satisfied and confirm the resolution. If resolution is not agreed, either the existing operator continues to work with the service request or the service request is re-assigned to another person for resolution. If the service request is of the highest priority, then the Service Desk management may be informed.

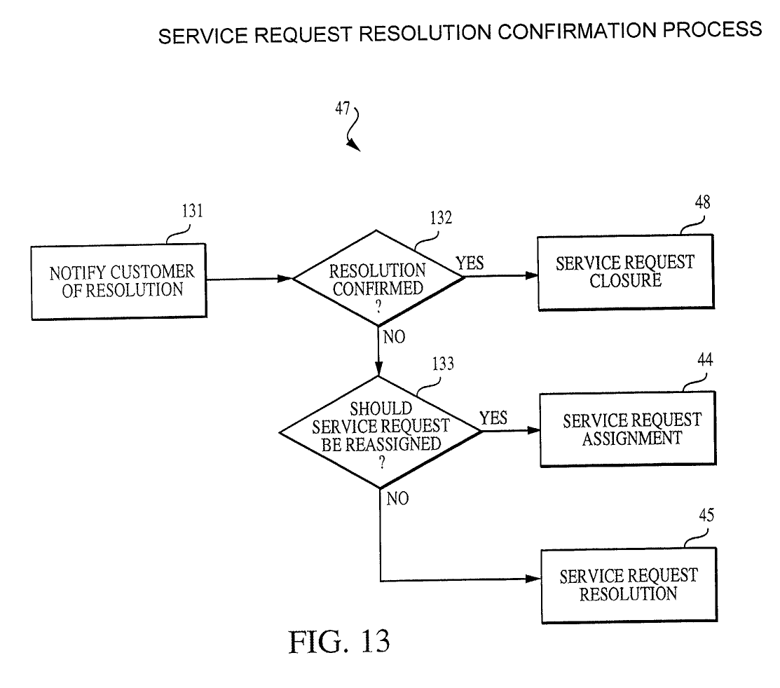

FIG. 13 is a flow chart of a process of confirming resolution 47 of a service request. If a service desk operator or assignee believes he or she has resolved the service request, he or she may notify the requester or customer 131. If the customer confirms that the request has been resolved 132, the service desk person may then move for closure of the service request 48. However, if the request has not been resolved to the satisfaction of the requester 133, the service desk person should decide whether he or she can solve the problem, and then proceed for resolution of the request 45. If the service desk person believes that reassignment or escalation is appropriate, then the service desk person begins the process of assignment or reassignment 44.

After resolution confirmation, the service desk process proceeds to service request closure. When a service request is closed, it is important that the solution is documented clearly, and the initial request description is fully detailed. Complete resolutions to defined problems, or steps to fulfill a request, will be logged in the knowledge database and can be used again for future calls. Well-defined requests and solutions can save significant time and allow high resolution rates of first level support, helping to improve response time/service and reduce costs. Service request resolution confirmation and closure can be performed either by the assignee or by the Service Desk Level 1 operator who logged the initial problem, depending on the organization of the Service Desk. It may be beneficial for as few people as possible to have contact with the customer to provide good service.

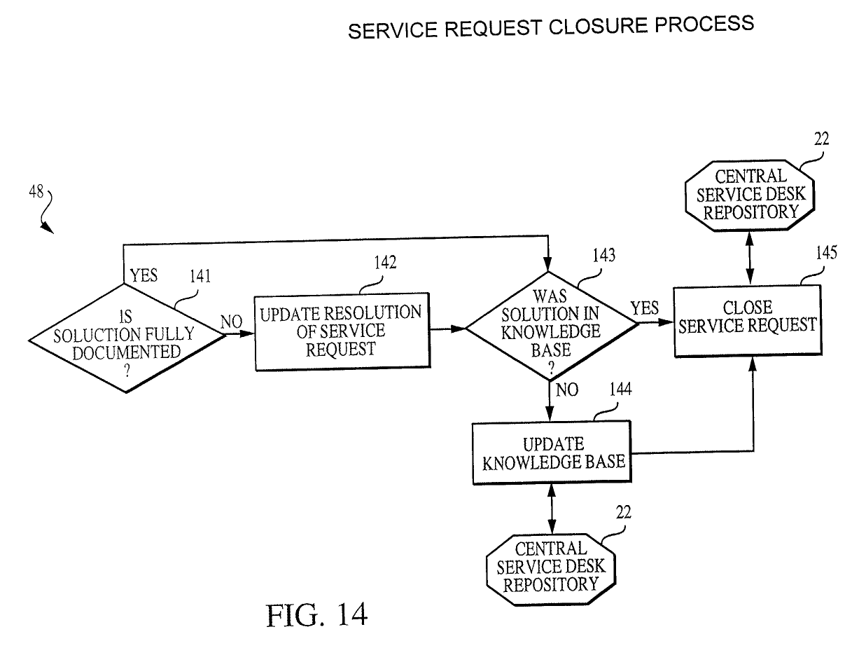

FIG. 14 is a flow chart for a process 48 of requesting closure of a service request. Once the requester agrees that the problem or incident has been resolved, or at least a work-around is acceptable, the service desk person may begin this process of closing the service request. If the solution to the incident or problem is not fully documented 141, it may be necessary to update resolution of the service request 142 (with the requester, such as by an assent or approval from the requester). Once this portion is complete, the service desk person should decide for future reference if the solution was in the knowledge base accessible to service desk personnel 143. If not, the knowledge base should be updated 144, perhaps by an input to a central service desk repository 22. If the solution was accessible from a knowledge base, the service request may be closed 145, perhaps with a note to the central service desk repository 22, if only to note the requester and the problem so that statistics may be kept and reported.

Knowledge Repository Management

A knowledge repository and a process for managing the accumulated knowledge may be very useful in helping the service desk function perform in a timely and effective manner. A knowledge repository management process identifies common service requests (simple service requests, incidents, problems and user administration requests) in the service request tracking tool and reviews and approves associated resolutions. Areas are identified where new knowledge is preferably created, updated or simply communicated to the Service Control teams. This also involves deleting obsolete knowledge (for example, Windows 3.1 resolutions where Windows 3.1 has been replaced with Windows NT). Knowledge repository management co-ordinates with the business unit and IT enterprise experts in developing and publishing knowledge (top 10 resolutions) to improve the resolution rates at Level 1.

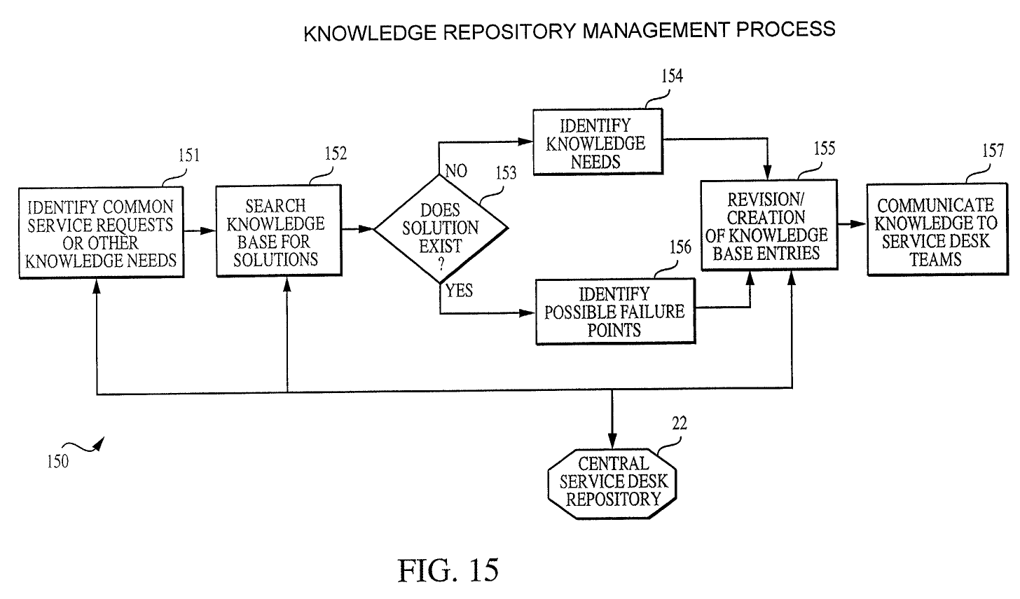

FIG. 15 is a flow chart for a process 150 of storing and managing knowledge relevant to service requests. On step is to identify common service requests (repeated requests for the same service or knowledge) and to identify other knowledge needs 151. A service desk user may search an existing knowledge database for solutions to such a service request 152. The user may face the question as to whether a particular solution to a particular service request exists 153. If not, the user should identify the knowledge needs 154 and create or revise entries of such knowledge 155 in a central service desk repository 22. If the knowledge or solution already exists, the service desk user may wish to identify possible failure points for particular solutions 156, and then create or revise entries 155 in a central service desk repository 22. An efficient service desk organization would then communicate this knowledge to other service desk personnel or teams 157, or in some cases, perhaps to customers of the service desk as well.

The knowledge repository and knowledge repository management may also be used proactively for future problems. By working closely with Root Cause Analysis, it is possible to publish resolutions and prevent problems from recurring. Although knowledge is usually stored within a knowledge base, it may be beneficial to publish a newsletter or web site with details of ‘Top 10 resolutions’ so that customers can resolve certain problems themselves, without having to call the Service Desk. Knowledge Repository Management is typically performed not by a ‘standard’ level 1 analyst, but by a level 1 lead or manager.

Service Level Control

Tracking, monitoring and control processes should be used to ensure that the quality of service offered to users is satisfactory. It is important to include some form of qualitative research in the Service Level reports to maintain a balanced picture of the service provided. Even if measured service levels are showing service requests as being closed within target times and Tier 1 resolution targets being met, the Service Desk customers may not be receiving the service they require. In the worse case users may simply not be calling the Service Desk.

Service Desk management can obtain information on qualitative service levels. This can be achieved making use of subjective user perceptions of the Service Desk organization with the use of customer surveys. Management may also perform random quality analysis of calls and service request records

Customer surveys can include questions similar to those listed below, used with a scale of 1=Never True, 2=Seldom True, 3=True 50% of the time, 4=Usually True, 5=Always True.

1. Staff are knowledgeable.

2. Staff are polite.

3. I have confidence that that Service Desk will help me.

4. I have no trouble getting through to the Service Desk.

5. My call is either handled over the phone or logged and resolved in a timely manner.

6. The Service Desk meets target dates and times that it gives me.

7. The Service Desk keeps me informed of progress on calls that cannot be resolved immediately.

8. The Service Desk keeps me informed of planned down times.

9. The Service Desk informs me of changes in the environment (such as software upgrades, new software or systems, and so on).

10. Using the Service Desk makes me more productive.

More open-ended questions may also be included, such as:

A. What are some expectations of the Service Desk that your group has?

B. How would you describe the level of PC growth or systems change?

C. What do you believe are the most common Service Desk calls?

D. Other comments:

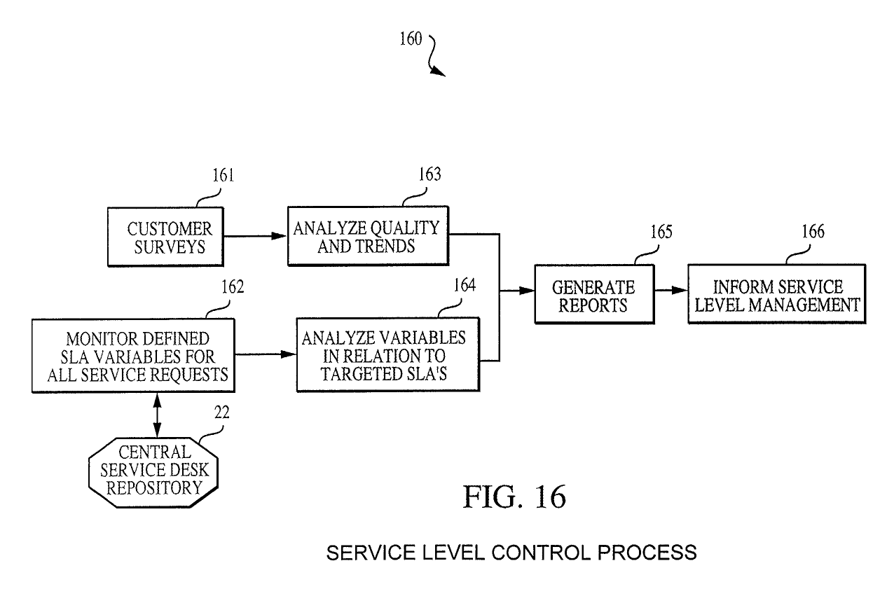

FIG. 16 is a flow chart for a process 160 of providing service level control. The service desk organization may use a variety of techniques to insure that its performance is on target and that the quality of service offered to users is at least satisfactory. The service desk organization may commission customer service surveys 161 and monitor defined service level statistics 162 to measure user satisfaction. Statistics on performance and results of surveys may be stored in a central service desk repository 22. In some environments, voluntary user comments, not available in surveys, are another indicator that the service desk organization is performing at a high level. Customer surveys may be analyzed 163 for overall quality of service and trends in the overall quality and performance of the organization. Statistics and variables tracked may be analyzed 164, especially in regard to their relation to agreed-upon levels of service. Service desk personnel may then generate reports 165 for internal use and to inform senior management, for instance, senior management of the service desk provided or senior management of the customer or user organization.

In addition to qualitative control, quantitative metrics may also help gauge the performance of a service desk. Quantitative control should, if possible, be defined within an SLA. Quantitative control could include the time to respond and time to resolve service requests. Performance could be measured using the following formulae:

$$\frac{Solved Requests within the SLA Target Time}{Solved Requests} * 100 \%$$

Note that this metric makes use of the status value “Solved”, which needs to be defined in the Service Desk tool.

First pass resolution. First pass refers to the request being resolved the first time around without the need for it to be re-opened by the customer. This helps to ensure that the Service Desk is resolving the problem first time around. This measure can be used to show the quality of the Time to Resolve above. This can be measured using the following formulae:

$$\frac{Closed Requests where Reopened = 0}{Closed Requests} * 100 \%$$

First Call Resolution. This can be used to measure the number of service requests that were resolved during the first call. The following formulae provides and example:

$$\frac{\begin{matrix}Requests that have been directly \\ saved to the closed or solved state\end{matrix}}{All closed + solved Requests} * 100 \%$$

Call Abandonment Rate. Example formulae:

$$\frac{Number of dropped calls while in queue}{Total amount of calls announced to queue} * 100 \%$$

Call Wait Time. The telephony system will be able to measure the average time a customer has to wait in a call queue before being answered.

Request Handling Rate. This can be used to trend the overall productivity of the FTEs. An example formula is

$$\frac{Number of solved requests}{Number of FTE ' s} * 100 \%$$

Major Organization Function Resolution Rate. This can be used to monitor the trends in groups within an assignment tier level as they resolve Service Requests.

$$\frac{Number of dropped calls while in queue}{Total amount of calls announced to queue} * 100 \%$$

Number of Open Requests. This metric shows the basic backlog of open requests at any particular time. A snapshot of this measure could be taken at the same time each day to provide useful data for trending.

Number of Logged Requests and Solved Requests. Absolute figures can be taken to show the details of the total numbers of requests. Snapshots can be taken daily to provide useful data for trending and to monitor any changes in growth rates.

Number of Complaints. If a complaint mechanism exists to allow customers to provide feedback on the service they have received the number of complaints can be captured and trended.

Tier 1, 2 or 3 Resolution Rate. For each tier the resolution rates can be calculated, for example:

$$\frac{Requests solved at Tier 1}{Requests where Tier 1 is owner} * 100 \%$$

Other Identified Key Performance Indicators (KPIs) may include the training level of Service Desk staff, effective compliance with procedures, knowledge of company processes and tools, availability of proper documents, and so on. Also useful may be the number of inbound calls, the number of out of timetable calls (received by e-mail or answering machine), and so on.

The Service Desk analyst or manager should periodically obtain service desk reports with target metric information on the service level provided by the Service Desk as a whole to the organization, the service level provided by support groups in solving their assigned problems (Tier 2), and the service level supplied by external providers in response to requests from the Service Desk (Tier 3). Periodic polls and reports should assist the service desk manager in the evaluation of these high-level target issues.

Root Cause Analysis

Root cause analysis is a tool and a process to identify repetitive requests or incidents, as well as chronic problems, in order to provide a proactive response and improve service levels. The following tasks can be carried out periodically to assist in root cause analysis:

Use the Service Desk tool search and reporting facilities to identify and report on the most common categories of service request during a given time frame.

Produce a trend over the history of service requests by category.

Use search facilities and reports to identify those assets or types of asset that have been subject to the most frequent service requests during a given time frame.

Produce a trend over the history of service requests by asset.

The results can be used to identify underlying problems that continually cause service requests. An example could be a steady increase in the number of calls as a result of memory problems with a certain PC platform. This could show that a general PC upgrade is required. If the cause is related to an event that is likely to re-occur (that is, not an extraordinary event) then further action can be taken, such as opening a service request to resolve the underlying problem, or interfacing with other IT Framework functions to prevent the issue from re-occurring.

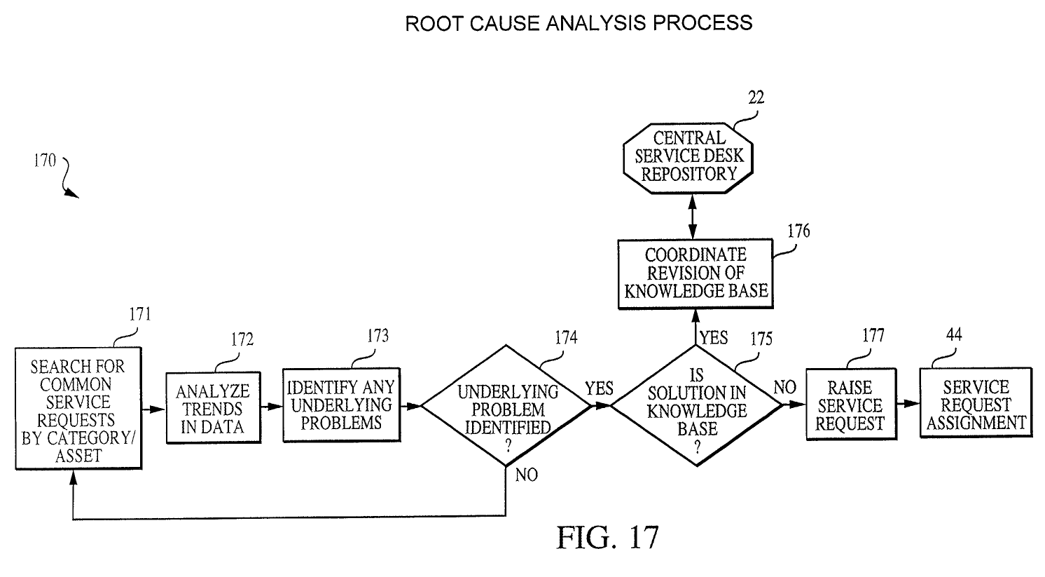

FIG. 17 is a flow chart for a process 170 of analyzing a problem or an incident for the root cause of the problem or the incident. A service desk analyst may search a common service desk repository of knowledge 22 or other data base for common service requests 171 in a number of ways, e.g. by asset (particular type of computer), by problem (particular application software issues or difficulties). The analyst then searches for trends in the data 172, and perhaps identifies underlying problems 173, for instance, by using a “fishbone” analytical technique. If no underlying problem is found 174, the analyst may repeat his or her search, perhaps by a different technique or by searching for different variables.

If, however, an underlying problem has been identified 174, the analyst may then search to determine whether the solution is available 175 in a common service desk repository of knowledge 22. If so, the analyst may then wish to coordinate with other service desk personnel 176 to revise the knowledge repository 22 to make it easier to identify this particular solution to a particular problem. If a solution is not available, the analyst may issue a request for the solution 177 and seek assignment of the request 44.

Service Desk Organization

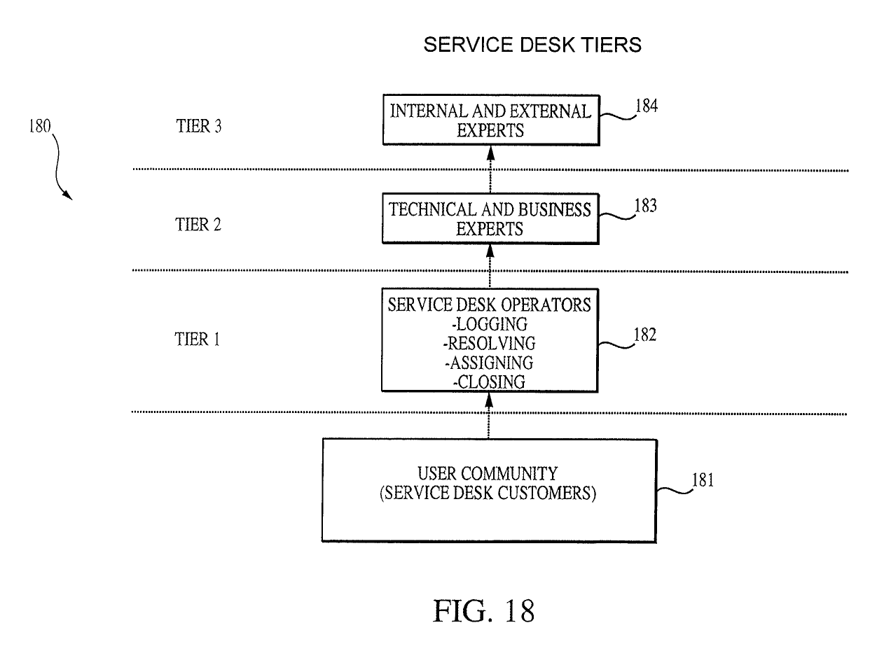

FIG. 18 depicts the tiers 180 of a service desk. There may be three tiers, or counting the users themselves, four tiers (with the customer as Tier “0”). The entry tier is the user community 181, the customers of the service desk organization or function. The first tier within the service desk organization is Tier 1 182, staffed by service desk operators, also known as analysts. The second tier is Tier 2 183, with technical and business experts having greater knowledge and experience than Tier 1 analysts and operators. The top tier is Tier 3, with the highest level of perhaps internal and external experts that are available to the service desk function, and thus, ultimately, to the service desk customers.

There are three general options for locating a Service Desk, including a location centralized in one place, a central hub with some staff distributed to other locations, and decentralised with no central location. Among the factors that pull the majority of Service Desk functions into one location are the existence of an established Service Desk, and the central location of key contacts of other organizations, especially those performing other information technology organizational functions.

A primary consideration when deciding whether to move some functions away from a central location, is the criticality of the business function being performed in the location, and the capacity for a fault in the location to be resolved remotely. The choice of support tools, not just for the core Service Desk functions, but also for Fault Management will directly influence this area. Where such on-site Service Desk personnel will be assigned to locations with many users and/or critical technical components, care should be taken in defining the duties of these on-site personnel so that they are not burdened with performing tasks that distract them from their primary Service Desk role.

The process of defining both the skill requirements for the Service Desk and the locations for its resources will often lead to a tiered structuring of the organization. Each tier has an increasing level of skill, with tasks and responsibilities distributed accordingly. This tiered structure allows skills and expertise to be related to the functions performed at each tier in a cost-effective manner. Costs are controlled by ensuring that experienced staff with high levels of technical skills carry out only those functions that are appropriate to their skill levels. A three-tier system usually provides the best results for service request and problem management, however this may vary depending on specific requirements and availability of resources. For example, it may in some instances, be beneficial to have ‘super users’ co-located with the business. The definitions of the standard three tiers are presented below:

Tier 1. Tier 1 personnel perform the first level of user support. This involves logging service requests, and attempting to resolve them directly over the phone with the user. If immediate resolution is not possible, the request is assigned to more skilled personnel. Depending on call volume, the number of staff available, and their ideal utilization figure, Tier 1 personnel might also be responsible for tracking service requests, and for providing status information to users regardless of the level to which a service request has been escalated. Tier 1 handles and resolves as many requests as possible. As the first contact using the tools and knowledge at the service desk, Tier I should always be the single point of contact for a user's request or incident handling.

Tier 2. Tier 2 personnel are more skilled than Tier 1 and are responsible for handling service requests that could not be resolved by Tier 1, or when escalation procedures dictate. Tier 2 personnel might also perform Monitoring, Event and Fault Management, and SLA Reporting, if these functions are within the scope of the Service Desk organization. Tier 2 personnel, with more technical and business expertise, resolve the more difficult problems or specialized requests.

Tier 3. Tier 3 personnel are usually the designers and developers of the systems. These could be the application development or maintenance staff, network management, certain operators, or 3rd party vendors. Service requests are escalated to Tier 3 personnel when Tier 1 or Tier 2 personnel are unable to resolve them. It is unlikely that Tier 3 personnel will have direct contact with users, normally maintained through either Tier 1 or Tier 2 resources. Note also that Tier 3 may represent an external organisation, where specific products have been purchased. Tier 3 resolves problems that cannot be resolved by the first two levels of support and require additional technical or programming expertise or vendor assistance.

Other possibilities exist other than those represented above. Tier 1 could consist of a logging function only with no attempt to resolve issues. Tier 1 staff gather information and immediately assign the issue to the relevant support group. This type of Service Desk is often used with external customer technical support.

Service Desk Staffing

The effort required to perform Service Desk functions can be calculated by estimating the hourly Full Time Equivalents (FTEs) required. With a consideration of timetables and shift work required to match the profile the actual resource requirements can then be estimated. The calculation of Full Time Equivalents (FTEs) required to operate the Service Desk is relatively simple. Estimating the factors that make up the equation can prove very difficult unless there are existing examples.

To calculate the FTE figures, the total number of hours required per given period to resolve service requests is calculated. This is achieved by taking the number of service requests received during a given period and multiplying it by the average time spent on a service request. The simple equation for this is:

Total hours required (per Period)=Number of cal/tickets raised (per period)×Average time spent on each call/ticket

Taking the above equation on an hourly basis provides the number of FTEs required:

Number of FTEs required (per hour)=Number of call/tickets raised (per hour)×Average time spent on each call/ticket (in hours).

For large Service Desk operations that more closely simulate a call center environment (large Tier I desk operating relevant automatic call distribution technology) queuing theory calculations may be relevant in calculating the number of operators required. These calculations are based around the work performed by the A. K. Erlang (1878-1929). His formulas are still used today in calculating these figures and are typically referenced as Erlang C algorithms. Erlang B algorithms may also be used.

The Erlang C algorithms (or queuing theory as it is often called) can be used to calculate the relationship between:

Average talk time

Average after call time (wrap up time)

Service level objective time (90 seconds)

Percentage to be handled within objective (90%)

Calls expected in half hour or hour period

Number of people required on the phones.

The algorithms may also be used to provide details relating to:

Number of callers not receiving an immediate answer

Number of callers receiving an immediate answer

Average speed of answer (ASA)

Average delay of delayed calls

Abandonment rate (number of callers hanging up when on hold)

Caller waiting profile (number of callers waiting for more than 5, 10, 20 seconds, and so on)

For Service Desk response, the abandoned calls rate should be considered an extremely important metric, which can cost the business money due to individuals attempting ‘self-solved’ or ‘friend-involved’ problem resolution. In one embodiment, there is sufficient service desk staff such that no more than 1% of calls are abandoned; in another embodiment, no more than 5% of calls are abandoned.

The Erlang metrics can be used to develop comparisons of these figures. The following example highlights the differences between under and over staffing. If a call center is receiving 500 calls an hour at 240 seconds per call, and aims to answer 90% of calls within 30 seconds, 40 agents will be required. If 35 agents are employed, the average speed of answer (ASA) will be 100 seconds. If 45 agents are employed, the ASA will be one second. This shows that significant variation in customer satisfaction can result from relatively small changes of agent numbers.

Service Desk Additional Areas

The following section includes details for the implementation of a Service Desk in relation to situations for Service Desk support for Internet/e-Commerce applications, Service Desk support for global organizations, and outsourcing the Service Desk. Consultant and market research groups are predicting explosive e-Commerce growth. Forester predicts that world-wide Internet commerce will grow from $80 billion of goods and services in 1998 to $3.2 trillion in 2003. Other research groups support these predictions. This growth will have an impact on Service Desk work, as increasing numbers of organizations develop Service Desk support for their e-Commerce and Internet based systems.

As shown in FIGS. 1 and 2, e-Commerce may extend the scope of a Service Desk towards external customers and may include integration with traditional Customer Relationship Management (CRM) activities to cover services other than those related to information technology. The original IT Service Desk's customers were the internal staff of the organization making use of the organization's IT services. The Internet and e-Commerce extends the use of the IT services to partners, suppliers or customers.

Examples exist in organizations, such as Cisco Systems, which use the same applications both internally (intranet) and with business partners (extranet). These systems/applications require adequate support. Many other direct customer examples exist on the Internet including Cisco, banks, brokers and general retailers. While most of the principles that apply to an internal Service Desk remain valid, there are a number of additional areas that should be considered. These may be applicable to some or all of the net-centric architectures that support e-Commerce applications (that is, Internet, intranet or extranet) and can be broadly categorized in relation to:

The Service Desk dealing with external customers and becoming external customer facing.

The possible anonymity of the customer base served.

The potential for huge volumes and geographic disparity of customers served.

The multiple parties involved in the delivery of an Internet technology based solution.

The need to integrate business services with IT services.

The key points from this section include

With web-based systems, users are required to support themselves much more (consider most Internet sites including Microsoft and Cisco). This raises the Change Management issue of whether users are able to perform this ‘self support’. Short term effort in developing training/tutorials for, for example, downloading a new release of software may significantly reduce later demand on the Service Desk.

As e-Commerce work is still very much in its infancy, existing problem knowledge bases may not contain solutions to common problems. There is still a learning curve that the Service Desk needs to overcome. Staff training and effort to build in the knowledge required are important.

With e-Commerce applications, partners, suppliers and direct customers require direct technical and functional support, and therefore the IT Service Desk face and interact with external customers. The issues relating to this include, but are not limited to response and resolution times, the ability of the Service Desk to respond, and control over customer contacts. Response and resolution times become critical with external customers, as poor service can mean loss of business. Customers may see the Service Desk as representative of the quality of the organization and the products/services provided by the organization. Support service levels that may have been acceptable for internal customers may be unacceptable for direct customers. For Internet purchasing, it is worth considering the ease with which a consumer can find substitute products/services and shop elsewhere.

The ability of the Service Desk to respond is very important. With external customers, it may be difficult to guarantee the traditional levels of responsiveness of the Service Desk. For example, an existing target may be to respond to a high-priority incident within a certain time, and then provide regular updates at agreed intervals. If the Service Desk user communication now takes the form of Internet-based e-mail, the uncertainty this introduces in terms of time-scales for Internet e-mail delivery may impact previously established targets. It may not be possible for the Service Desk to still promise a two-hour turnaround on an incident when they may not even receive the initial email after one hour. Also affected may be the issue of Customer Contacts. It may be unacceptable for parts of the Service Desk to have direct contact with the customer. This may be especially true of some Tier 2 or 3 staff in an internal Service Desk, who are generally more technically focused and were not recruited as customer contacts. It may be necessary to train staff to be able to deal directly with customers. Alternatively, the Service Desk process could be adapted to ensure that there is no customer contact beyond a certain tier.

Anonymity of Customers. In an Internet based application the user group can extend beyond known customers to completely anonymous Internet users. The issues here relate to familiarity with the customers and typical problems of the customers. When an external customer logs a service request to the Service Desk, the Service Desk may have no prior experience with this external customer. If customers log issues through an e-mail system, it may be more difficult to contact the external customers if additional information is needed. Previously defined service levels, which were adequate for internal customers, may be at risk if the customer cannot be contacted to clarify information.

The Service Desk Repository of information on Internal Customers likely will have information stored concerning configuration details, location, contact details, and so on. When dealing with external customers additional information may be required, such as asset and software details or customer location details. Additional process steps may be required to log these details. It will be more difficult to provide customers with proactive service information in the case of either a major system failure or scheduled system down time. To overcome this it may be possible to provide automated mail back to all incoming service mail during a serious system failure, or use similar telephony techniques, if practical.

If the resolution of a service request involves the distribution of materials such as files, updated code, training materials, or hardware, adequate procedures for distribution should be in place. This could result in an increased use of e-mail or web-site file downloads for the distribution of these materials.

Volume and Global Disparity of Customer Base. Many Internet applications will be available to a vast customer base that can be located anywhere in the word. Issues relating to this may include extra support staff vs. self-help, change administration, global 24×7 customers, global language support, and additional metrics to measure Service Desk performance.

Internet based applications can have a potentially unlimited number of users and customers operating a variety of technical environments (varying PC configurations). Accurately predicting growth in numbers of users of these applications can also be difficult. Such unpredictable variables make estimating support requirements very difficult. To help limit vast numbers of service requests a system of ‘self help’ or Frequently Asked Questions (FAQs) can be developed within the applications to enable customers to support themselves. More sophisticated ‘self help’ could also be used such as virtual service representatives programmed to provide realistic ‘discussions’ with customers. These self help functions should aim to resolve the typical 80% of ‘common problems’ of system users. Other solutions could include on-line help, tutorials or troubleshooting guides.

The impact of poor change control on an Internet based application can lead to a sudden huge peak in the number of calls to the Service Desk. The result of a badly tested application release may affect significantly more people in an Internet environment than an internal environment. Announcements of new or free software could create a sudden increase in demand in that changes in content can suddenly create a response from users. While much of the responsibility here lies with Change Administration, it is important that the Service Desk remains closely integrated into the Change Control processes to ensure that appropriate levels of service are maintained.

If the application is global, then consideration is preferably given to the need of customers to log urgent service requests at any time of the day. The process of handling these service requests should be analyzed and may include some form of global support. If necessary, 24×7 support can be purchased from an outsource rather than being developed internally. Global support can also enable 24×7 work on specific service request Tickets. In addition, depending on the nature of the customer base it may be necessary to offer multi-lingual support.

Additional metrics may be utilized to monitor the volumes of calls and the response of Service Desk staff. These can be added to the standard Service Desk metric measurements and may include new key figures, such as the number of e-mails answered per hour. Some of these new metrics may also require new measurement tools such as web site monitoring tools to measure the number of hits on a self-help page).

Multiple Parties Involved in Service Delivery. Internet, intranet or extranet applications increase the number of groups involved in delivering the IT services. These can include internet service providers (ISPs), credit authorisation services, digital signature verification services, public key look-up, network providers, telcos, web hosting, content providers, and also the end users (with PC, modem and personal software configuration). The issues relating to this include escalation processes and operational level agreements (OLAs).

With so many 3rd parties involved in the delivery of services, difficulties may arise due to hand-offs between the providers. Escalation procedures should be clearly defined in OLAs between the Service Desk and the parties involved. Within the escalation process, the Service Desk may decide when they are no longer responsible for an issue, for example if an external customer's PC is at fault the Service Desk will not be in a position to fix the problem. As more companies move their traditional business processes towards e-Commerce, the dependency on 3rd parties increases, requiring strict and effective OLAs. What might have been a sound OLA with an Internet Service Provider for basic Internet access, may no longer be adequate if this access now needs to support a mission critical process.

Integration of IT Processes and Business Processes

The Service Desk may need to be integrated with other processes being supported. Without such integration, there is a risk that the customer may be given the incorrect information, be forwarded to the wrong department, or otherwise mishandled. Issues relating to integration include new IT/business processes, call center integration, customer relationship management (CRM), and customer feedback.

An e-Commerce application may introduce new processes to an organization. Many of these new processes can be technology intensive (for example, integration of new customers to a web hosting service, rolling security keys to business-to-business transactions, and so on), and it is important that responsibilities are clearly assigned between the IT organization and business groups.

An organization expanding into e-Commerce, may make use of existing call center staff or technology to provide the point of contact with the customers. The existing staff will have to be trained to deal with the additional range of requests. The Service Desk and the CRM function may be integrated to provide a single point of contact support to customers. The customer may be contacting the organization for a number of reasons ranging from technical to functional to product/service queries to finance options, delivery options, and so on. An effective single point of contact provides excellent service. This integration can be implemented in stages. Initially the CRM function can act as the first point of contact for all calls, and forward IT related calls to the IT Service Desk. In later stages, the CRM function can assume some of the Service Desk Tier 1 responsibilities.

The Service Desk can form a useful feedback loop from the end users to the web designers and developers. Information collected by the Service Desk should be shared with other interested groups such as the authors of the web site (content management). This activity is enabled by the availability of web-site management tools, which allow detailed web-site usage analysis to be performed. This information can be invaluable to, for example, a marketing department interested in assessing the success of new web-site contents/products.

Service Desk Support for Global Organizations

With more and more organizations operating globally, there is an increasing demand for the implementation of global Service Desk support. Some of areas to consider for Service Desks operating on a global basis include service desk models for global support, time zone considerations for global support, and multiple language support options. The structure and location of the individual tiers of support is a very complex issue for a global organisation and are preferably developed in line with the IT support organisation. This will include a complete management and support structure with authority and credibility to make global decisions and direct local operations. Details and guidelines regarding the IT support organisation may be considered as part of an IT transformation program.

Global Service Desk Models

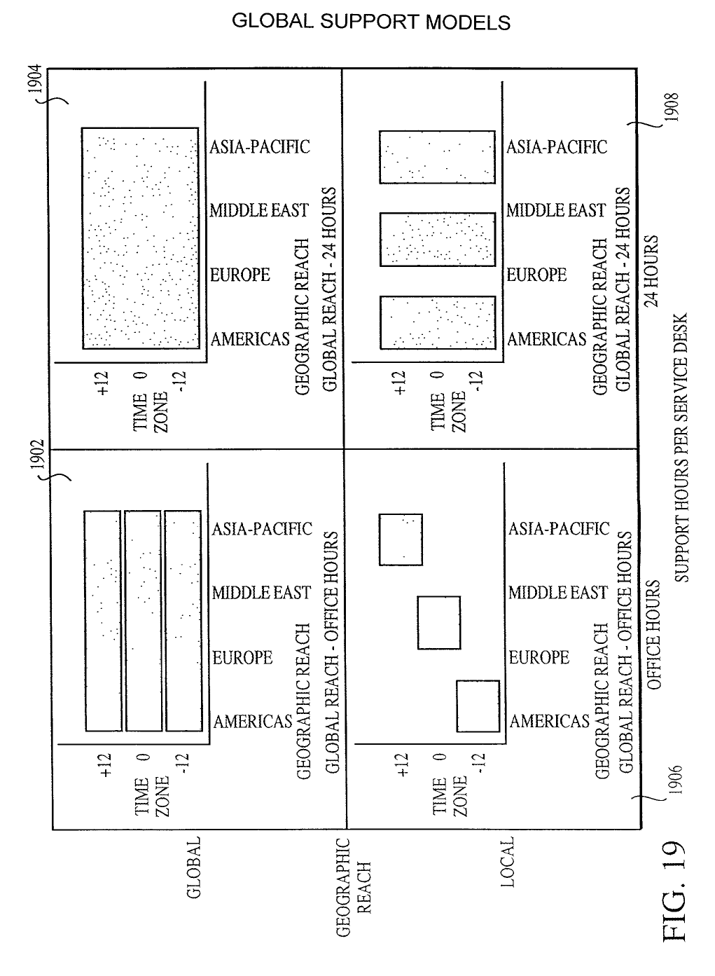

The number and location of Service Desks used together with the structure and staffing models of each Service Desk will depend on the exact circumstances of each organization. Four general models are presented below, which may be used to discuss and select the best fitting global model. The actual solution used is likely to be a hybrid of two or more of these models. The main dimensions that differentiate between the four models are geographic reach and support hours. FIG. 19 depicts four such service desks, 1902 (global reach, office hours only), 1904 (global reach, 24 hours a day), 1906 (regional reach, office hours) and 1908 (regional reach, 24 hours a day), differentiated by global reach and support hours per service desk.

The geographic reach describes the number of geographic regions serviced by each Service Desk, the two extremes being complete global coverage or local coverage only. The support hours per Service Desk describe the number of hours during which the Service Desk is operational. The two ends of the scale being 24-hour service and standard working day coverage. FIG. 19 describes the relationship between these factors and answers the question “Which Service Desk do I call based on my location and the current time?”

Regional Reach - Office Hours (FIG. 19,1906). An example of this model would be a company operating a Service Desk in multiple regions (perhaps countries or continents) around the world with each Service Desk servicing that distinct region for the local working day. This model is the only model that does not provide 24-hour service to customers. This support would be necessary where distinct technology, processes or local culture dictates the need for a localized support and the nature of the work does not require 24-hour support. The specific need for multiple language support may dictate a localized support approach. This support is often the first type of support to exist as a company expands globally. Over time, and as processes and organization structure are standardized, the organization may seek a more global reach support structure.

Regional Reach - 24 Hours (FIG. 19, 1908). This model is the same as that presented above, but with each Service Desk operating around the clock to achieve 24-hour coverage.

Global Reach - Office Hours (‘Follow the Sun’) (FIG. 19, 1902). An example of this model would be a company operating a number of Service Desks around the world, allowing for 24-hour world-wide coverage but with each Service Desk only operating during local office hours. The number of Service Desks required would depend on the nature of support necessary. For support that could be directed to any Service Desk throughout the day, three centers operating for eight hours per day would be sufficient to achieve 24-hour coverage. For more specific location support, time zones are carefully considered. This type of support could be used where processes and technology are relatively standardized to allow support from any Service Desk, but where the culture, degree of local support or cost dictates that a single global 24-hour Service Desk cannot be used. This model could become technically complex when issues are passed around the world to enable work to continue on specific issues for 24 hours, perhaps to achieve specific service levels.

Global Reach - 24 Hours (FIG. 19, 1904). An example of this model would be a single Service Desk serving the entire world operations 24 hours a day. This support would be possible where technology, processes and company culture are relatively standardized throughout the world and customers all speak a single language, or the support center staff can support all the languages necessary. The costs of this support may become prohibitively high with the need for numerous skilled staff operating 24 hours a day.

Hybrids. In reality most Service Desks would be a hybrid of two or more of the above models. For example, a company may operate a ‘follow the sun’ organisation but with local staff in operation at individual sites and a main Service Desk with some 24-hour coverage. This will depend on the structure of the support organisation and the technology skills/support required.

Language Barriers. To overcome language barriers, it may be necessary to create a multi-lingual Service Desk with either multiple locations or multi-lingual staff at a single or limited number of locations. The Service Desk should make use of local key users who can translate issues and resolutions. These key users become the first line of support for other users. At all times of the day a multiple language Service Desk may be required to support all products in all necessary languages. This may lead to a significant increase in staffing levels. When hiring, language should have the priority over business/technology Knowledge. Learning business/ technology at this level will take only a few weeks to a few months, while learning a new language will take a few years. It is a good idea to hire staff fluent in as many different and relevant languages as possible.

Outsourcing the Service Desk

The market trends for outsourcing show continued growth. International Data Corporation measured the technical support and Help Desk outsourcing market at $7.8 billion in 1998 and expects this to grow to $17.4 billion in 2002. Whatever the exact figures, there is no doubt that the market continues to be a growth area.

Consulting firm META Group, Inc., Stamford, Conn., U.S.A., makes similar predictions. One of their key META trends states that successful IT organizations will establish a customer support center responsible for managing relationships and service levels with internal end users. A critical component will be a consolidated help desk providing cross-discipline problem resolution and complete service request tracking. META predicts that most organizations will accomplish these goals by out-sourcing. The concept of information technology outsourcing is a situation different from the outsourcing of the Service Desk, and these opportunities should be considered separately. Organizations are preferably comfortable with the concept of outsourcing before individual outsourcing options are considered (such as network, data center and desktop).

A total outsourcing solution is expensive and generally difficult to achieve. It is advisable that outsourcing be used on a selective basis (sections of Tiers 2 and 3) or as part of a larger IT outsource agreement. Outsourcing the whole of the Service Desk on its own is generally not recommended. The Help Desk Institute 1999 customer survey appears to support this advice. They found that 40% of support organizations outsource some portion of their operation while only 2% outsource all functions. Hardware support and off-the-shelf software support are the two most common outsource services.

An overview of the areas to consider in outsourcing the Service Desk follows, focusing on:

Benefits in outsourcing the Service Desk

Risks in outsourcing the Service Desk

Approach to successful outsourcing arrangements

Typical outsourcing options

Evaluation criteria for deciding on an outsource

Pricing considerations

A number of benefits that may be realized from an effective outsourcing agreement, including competitive advantages, access to technology and knowledge, and improved, consistent service levels. Outsourcing relieves the client executive management of the responsibility for managing non-core business processes and enables them to focus on the strategic business issues (competitive advantage). However, if the Service Desk forms part of the core competency of the organization, as in the case of customer facing support such as an Internet based bank, then it may be important not to outsource, and to develop or continue to develop internally.

Outsourcing can allow the client organization access to expertise, new technology, tools and techniques. It can allow the client organization to ‘buy in’ specialized knowledge. Building and maintaining leading edge technology represents a significant investment for a single employer. An outsource, on the other hand, can leverage these investments across multiple clients, ensuring that all clients get the benefit of the latest technology support. The outsource is also able to employ a wide range of skills and expertise. It may be inefficient for the client organization to have all these skills resident internally, while the outsource can deploy them across a wide client base. The outsource is also able to continually upgrade skills and knowledge to remain at the leading edge of the industry.

Outsourcing can be used to help ensure quality with defined performance service levels. A specialist outsource will focus on and have a greater exposure to industry-wide best practices. Specialists will be better able to identify change initiatives to raise service levels or reduce costs. A Service Level Agreement (SLA) between the outsource and the client can help ensure that it is in the outsource's best interests to achieve and sustain best practice business processes. Note that poorly defined service levels may lead to a drop in service performance. There is no reason why good SLAs cannot be used with an insourced Service Desk.

Other advantages of outsourcing the Service Desk may include a better ability to manage risks, better geographic coverage and hours of operation, better staff retention, net-centric computing, and overall cost savings. Outsourcing may be used to manage the risk associated with investments and achieve predictable service costs with reduced capital expenditure.

Outsourcing can allow companies to gain cost effective geographic coverage of services, either nationally or internationally. Similarly it can allow an organization to extend its hours of support by employing outsourcing firms that offer 24×7 coverage (with the outsource company again making use of economies of scale with multiple clients supported by a single team). The outsource company can make it easier for the client organization to expand operations and quickly gain support in new markets. This is especially useful when an organization is expanding. A global outsource provider can provide the coverage required including multiple language support, an understanding of local cultures and technologies, combined with consistent procedures.

Service Desk support staff are often under-valued in an organization relative to other IT or non-IT staff. The Service Desk is often seen as a starting point to move on to other roles within the organization. This can lead to low morale and high stress, and a high turnover of Service Desk staff. An outsource arrangement can help to overcome these problems, with well-defined career paths and training plans for what are actually the outsource organization's key staff. There is also a recognized shortage of IT capital world-wide and this may make it increasingly difficult for an in-house Service Desk to successfully recruit in the market place.

The Internet enables the outsource to operate on a remote basis as opposed to an on-site basis, reducing the cost of implementation. In addition, the outsource may be able to provide a more cost-effective service than can be achieved in-house, although this should not be assumed. The outsource may have lower costs through better economies of scale, reducing the per-client cost of the (often substantial) investments required to operate a Service Desk. When evaluating the existing costs of the in-house Service Desk all factors should be considered (total cost of ownership) such as recruiting costs, training costs, floor space, equipment, software, management time, and so on.

There are a number of associated risks involved in outsourcing the Service Desk, including potential disruption of the service from new operators, a “them vs. us” mentality, loss of control, loss of skills, service level failure, and of course, relationships, cost and other HR issues. The Service Desk is often the primary ‘client facing’ function of the IT organization. There is a risk that the reputation and perception of IT as a whole is put at risk if the Service Desk fails to perform under the outsource. It is therefore important that information technology is outsourced, the outsource understands the relationships to other support functions, who the players are, IT policies, and so on. This is especially important with outsourcing in which no client personnel are transferred to the outsource, and therefore no ‘common knowledge’ is transferred. This happens more often in Service Desk outsourcing deals than with other IT functions such as desktop support. The economies of scale usually mean that the outsource is leveraging service from a remote site, located in a different city, and does not want to bear the impact of hiring/relocating client personnel.

There may be a ‘them’ versus us’ mentality between IT support functions that belong to different outsources and a mix of internal groups. Service requests can be handed off between groups, with unproductive ‘finger pointing’ taking place, all at the expense of the customer. This risk is mitigated with strong SLAs and strong leadership.

There is also the risk that the organization will lose control of the existing resources and skills it has invested in the Service Desks. These Service Desks may be considered a strategic asset by some organizations, who fear of losing control of this strategic asset. This strategic asset could include a comprehensive knowledge base containing “trade secrets” that has taken time and money to develop. There is, further, a risk that the vendor will fail to deliver the expected service levels. Although service levels and contracts may help to mitigate against this, very poor service may prove disastrous to the organization, to the degree that agreed-upon penalties cannot compensate. The outsource may also lack understanding of the business or industry.

Staff may be transferred from the client organization to the outsource and therefore the client may lose access to staff for other reasons such as projects. There may be strong political resistance to outsourcing and its (often incorrect) association with redundancy and downsizing. Also, local legislation can result in it being very expensive for the client organization to break the deal in the event of a wrong decision. The outsource agreement may prove very difficult to manage with complex communication requirements and a large investment required to create effective contracts and service levels. There will often be complexity in determining what is outsourced, the service levels to set the associated penalties and bonuses, the communication paths, and so on. The client may also become one of many Service Desk clients the outsource deals with and therefore the relationship and communication may prove difficult to maintain. With the continued large growth rate of the outsourcing market the outsource may experience resource shortages that make achieving service levels difficult.

There is a risk that the costs of the service will escalate over time. To manage the future costs of the agreement, long term pricing can be agreed in a short-term (for example, two year) contract.

A Successful Approach to Outsourcing

Key points for success include a strong service integration role, a long term partnership, carefully constructed service level agreements, and good communication between provider and customer. A single individual, from either the client or an outsource, should manage the organzation, where all parties clearly understand that this person has ultimate authority. The role should be a hands-on function filled by a strong person who can deliver to the mission and ensure all involved understand the mission. This role should be defined and accepted during the initial negotiations of an outsourcing deal. The effectiveness of this role will help to mitigate many of the risks highlighted above. This authority can help to stamp out the ‘them’ versus ‘us’ mentality, and ensure that flexibility can be introduced between the different parties when required. Ultimately, the manager may have to see that SLAs are modified as necessary.

Effective management should be established with the mutual interests of each organization documented in a long-term win-win partnership. They should together create a ‘shared vision’. Contractual failures arise most often when requirements are specified too tightly with little room for innovation or the ability of the outsource to respond to changing client needs. Service Level Agreements (SLAs) should be carefully created as part of the overall contract. They should ensure that the performance measure is effective. The SLA can also include some method of continuous improvement, to continually improve the service delivered. Incentives may be included in the SLA in the form of bonuses to encourage the vendor to excel in service performance. Penalties can also be used when service levels are not met (although to maintain an effective partnership, these should be used only as a last resort.). There is no reason why good SLAs can not be used with an insourced Service Desk.

Good escalation mechanisms should be in place to allow either party to rectify a situation where non-conformance occurs. This requires good communication between the partners. Client management should stay involved during the development of the service and during regular review meetings.

There are many ways to practice this invention. It will be appreciated that a wide range of changes and modifications to the method as described are contemplated. Accordingly, while preferred embodiments have been shown and described in detail by way of examples, further modifications and embodiments are possible without departing from the scope of the invention as defined by the examples set forth. It is therefore intended that the invention be defined by the appended claims and all legal equivalents.

While this invention has been shown and described in connection with the embodiments described, it is apparent that certain changes and modifications, in addition to those mentioned above may be made from the basic features of this invention. Many types of enterprises may benefit from the use of this invention, e.g., any enterprise wishing to use a service desk for a variety of functions. In addition, there are many different types of computer systems, and computer software and hardware, that may be utilized in practicing the invention, and the invention is not limited to the examples given above. Accordingly, it is the intention of the applicants to protect all variations and modifications within the valid scope of the present invention. It is intended that the invention be defined by the following claims, including all equivalents.

We claim:

1. A method of providing a service desk capability, the method comprising:
receiving a request for service from at least one customer selected from the group consisting of an internal customer, an external customer, a global customer, and an e-commerce customer;
logging the request;
categorizing the request
assigning the request for service;
resolving the request for service;
confirming resolution of the request for service; and
closing the request for service.

2. The method of claim 1, further comprising escalating the request for service.

3. The method of claim 1, wherein the request for service is received via one or more techniques selected from the group consisting of a telephone call, an e-mail message, an Internet message, an Intranet message, a pager message and a facsimile message.

4. The method of claim 1 further comprising generating a request for service upon detection of a fault in an information technology system.

5. The method of claim 1, wherein the request for service includes providing customer information to a central service desk repository.

6. The method of claim 1, wherein the request for service is logged via one or more techniques selected from the group consisting of manually logging and automatically logging by an event management capability.

7. The method of claim 1, wherein the process of logging further comprises noting or recording the type of request, automatically logging the request, and automatically assigning the request.

8. The method of claim 1, wherein the process of logging further comprises noting or recording the type of request, monitoring non-contact calls to the service desk, evaluating the request to determine whether information provided by the customer is sufficient, contacting the customer for more information if necessary, verifying whether the information is correct, updating the information if necessary, and entering the information into a service request.

9. The method of claim 1, wherein the process of categorizing the request includes determining the type of request, assigning a priority to the request, and sending the request for resolution.

10. The method of claim 1, wherein the process of logging further comprises noting or recording the type of request, verifying information provided by the customer, determining whether the information is correct, updating the information if necessary, and entering the information into a service request.

11. The method of claim 1, wherein the process of categorizing the request includes determining the type of request, assigning a priority to the request, and sending the request for resolution.

12. The method of claim 1, wherein the process of assigning the request includes evaluating whether an operator can resolve the request, resolving the request if the operator is able to, and releasing the customer from the call.

13. The method of claim 1, wherein the process of assigning the request includes evaluating whether an operator is able to resolve the request, and if not, determining an appropriate resource to resolve the request, and assigning the resource to resolve the request.

14. The method of claim 13, further comprising determining whether the request is urgent, and if so, facilitating an assignment of the resource.

15. The method of claim 1, wherein the process of resolving the request includes diagnosing the request, searching a knowledge base if necessary to resolve the request, determining whether a solution is known, and resolving the request if a solution is known.

16. The method of claim 15, further comprising confirming resolution of the request by notifying the customer of the resolution and confirming with the customer that the request is resolved, and closing the request if the customer agrees, while requesting assignment or resolution of the request if the customer does not agree.

17. The method of claim 1, wherein the process of resolving the request includes diagnosing the request, searching a knowledge base to resolve the request, checking whether an amount of time to resolve the request has exceeded an agreed-upon time, and if so, documenting steps taken to resolve the request, and requesting reassignment of the request.

18. The method of claim 1, wherein the process of closing the request includes documenting the solution, entering the solution into a knowledge database if the solution was not already in the knowledge database, and closing the request.

19. The method of claim 1, wherein the process of resolving the request includes analyzing and diagnosing the request, resolving the request, documenting a solution to the request, and closing or confirming resolution of the request.

20. The method of claim 1, wherein the process of resolving the request includes analyzing and diagnosing the request, checking whether an agreed-upon time for resolving the request has been exceeded, and if so, requesting reassignment of the request.

21. The method of claim 2, wherein the process of escalating the request includes following notification procedures, determining a status of the service request, evaluating whether escalating is appropriate, and assigning the service request to a higher tier.

22. The method of claim 1, wherein assigning the request is accomplished by one or more techniques selected from the group consisting of manual notification, a telephone call, an e-mail message, a pager message, and a service-desk tool-set application.

23. The method of claim 1, wherein categorizing is accomplished by a technique selected from the group consisting of manual categorizing and automatic categorizing.

24. The method of claim 1, wherein categorizing is used to accomplish at least one goal selected from the group consisting of determining the correct person or group to assign the request for service, enabling trend analysis of requests for service, providing cause and effect analysis, and providing a starting point for a knowledge tool mechanism.

25. The method of claim 1, wherein the request for service is categorized before assigning and after receiving the request for service.

26. The method of claim 1, wherein the request for service is categorized according to a multi-level hierarchy of categorization.

27. The method of claim 1, wherein the request for service is categorized according to at least one of a service request type and a service request priority.

28. The method of claim 1, wherein resolving the request for service is accomplished by using at least one tool selected from the group consisting of problem checklists, lists of error messages and probable causes of an error, a knowledge database, a search facility, remote access, and a diagnostic facility.

29. The method of claim 1, further comprising escalating the request for service if the request for service is not resolved within a time specified by a service level agreement.

30. The method of claim 1, further comprising quantitatively tracking, monitoring, and reporting service desk performance, including one or more reports selected from the group consisting of service level agreement compliance, first pass resolution, first call resolution, call abandonment rate, call wait time, Tier 1 resolution rate, Tier 2 resolution rate, Tier 3 resolution rate, number of open requests, number of logged requests and solved requests, and number of complaints.

31. The method of claim 1, further comprising qualitatively tracking, monitoring, and reporting service desk performance, including one or more reports selected from the group consisting of volunteered comments and customer surveys.

32. The method of claim 1, further comprising analyzing the request for service to determine a root cause for repeated service requests and chronic problems.

33. The method of claim 1, wherein the service desk capability is provided from one or more locations selected from the group consisting of a centralized location, a centralized location and at least one distributed staff member, and a decentralized capability having no single central location.

34. The method of claim 1 further comprising using at least one tool selected from the group consisting of number identification service, automatic number identification, automatic call distribution, a voice response unit, and computer telephone integration.

35. The method of claim 1, wherein the service desk capability is selected from the group consisting of information technology, human resources, finance, engineering, medicine, nursing, procedure, insurance, retail, and legal resources.

36. The method of claim 1, further comprising using queuing theory to determine the number of staff required for the service desk capability.

37. The method of claim 36, wherein the service desk capability is designed for an average speed of answer from 1 sec to 100 sec.

38. The method of claim 36, wherein the service desk capability is designed for sufficient staffing that a minimum of 90% of calls are answered within a time objective.

39. The method of claim 36, wherein the service desk capability is designed for staff sufficient that no more than 5% of calls are abandoned.

40. A method of providing a service desk capability under a service level agreement, the method comprising:
receiving a request for service from a customer selected from the group consisting of an external customer, a global customer and an e-commerce customer;
logging the request;
categorizing the request;
assigning the request for service;
resolving the request for service;
confirming resolution of the request for service; and
closing the request for service.

41. The method of claim 40, further comprising escalating the request for service.

42. The method of claim 40, further comprising qualitatively tracking, monitoring, and reporting service desk performance, including one or more reports selected from the group consisting of volunteered comments and customer surveys.

43. The method of claim 40, wherein the service level agreement is for an average speed of answer from 1 sec to 100 sec.

44. The method of claim 40, wherein the service level agreement is for a minimum of 90% of calls to be answered within a time objective.

45. The method of claim 40, wherein the service desk agreement is for no more than 5% of calls to be abandoned.

46. The method of claim 40, wherein the service desk capability is selected from the group consisting of information technology, human resources, finance, engineering, medicine, nursing, procedure, insurance, retail, and legal resources.

47. A method of providing a service desk capability, the method comprising:
receiving information about a service problem from a customer selected from the group consisting of an external customer, a global customer and an e-commerce customer, the information received from one or more techniques selected from the group consisting of a telephone call, an e-mail message, an Internet message, an Intranet message, a paper message and a facsimile message;
logging the problem by noting the type of problem, verifying the information provided by the customer, determining whether the information provided correctly states the problem, updating the information if necessary, and entering the information into a service request;
categorizing the service request by determining the type of request and assigning a priority to the request;
evaluating whether an operator can resolve the request, and if so, then assigning the request to the operator;
resolving the request within a predetermined period of time or escalating the request;
confirming resolution of the request;
identifying new solutions of service requests and entering the solutions into a knowledge management repository;
identifying service requests which are for a new type of service request, a service request with a high impact, and a service request with a high severity, and if so, analyzing said service requests for a root cause;
generating quantitative data concerning service desk performance of the service request; and
closing the request.

48. The method of claim 47 further comprising generating a report of service desk performance by gathering quantitative data from a plurality of service requests.

49. The method of claim 47, further comprising generating a request for service upon detection of a fault in an information technology system.

50. The method of claim 47, wherein the customer is an internal customer.

51. The method of claim 47, wherein quantitative data are selected from the group consisting of service level agreement compliance, first pass resolution, first call resolution, call abandonment rate, call wait time, Tier 1 resolution rate, Tier 2 resolution rate, Tier 3 resolution rate, number of open requests, number of logged requests and solved requests, and number of complaints.

52. The method of claim 47, wherein the service desk capability is selected from the group consisting of information technology, human resources, finance, engineering, medicine, nursing, procedure, insurance, retail, and legal resources.

53. A service desk for customers selected from the group consisting of an external customer, a global customer and an e-commerce customer, the service desk comprising:
a service desk computer network accessible by customers;
a system for solving problems and incidents reported by customers;
a system for confirming resolution of the problems and incidents reported;
a system for closing said problems and incidents; and
at least one service desk repository for storing information useful in solving problems and incidents, said repository accessible by the computer network.

54. The service desk of claim 53, wherein the system for solving problems and incidents includes problem checklists, lists of error messages and probable causes of an error, a knowledge database, an asset database, a search facility, remote access capability, and a diagnostic facility.

55. The service desk of claim 53, wherein the system for solving problems and incidents includes a multi-level hierarchy for categorizing said problems and incidents.

56. The service desk of claim 53, wherein the system for solving problems and incidents includes at least one tool selected from the group consisting of number identification service, automatic number identification, automatic call distribution, a voice response unit, and computer telephone integration.

57. The service desk of claim 53 wherein the problems and incidents are selected from the group consisting of information technology, human resources, finance, engineering, medicine, nursing, procedure, insurance, retail, and legal resources.

58. The service desk of claim 53, wherein the system for solving problems and incidents includes a prioritization schedule.

59. The service desk of claim 53, wherein the system for solving problems and incidents includes a system for assigning said problems and incidents selected from the group consisting of a telephone, a radio, a pager, a computer program, a facsimile machine, and a computer.

60. The service desk of claim 53, wherein problems and incidents reported to the service desk are divided into three tiers.

61. The service desk of claim 53, wherein the service desk computer network and service desk operators are at one or more locations selected from the group consisting of a centralized location, a centralized location and at least one distributed staff location, and a decentralized location having no single central location.

62. The service desk of claim 53, wherein the system for confirming resolution of requests includes telephone calls, e-mail messages, facsimile messages and user surveys.

63. The service desk of claim 53, wherein the system for closing said problems and incidents includes rules for documenting a solution to a problem or an incident and entering the solution into the repository if the solution was not previously known.

64. A service desk for customers selected from the group consisting of an internal customer, an external customer, a global customer and an e-commerce customer, the service desk comprising:
a service desk computer network accessible by customers;
a system for solving problems and incidents reported by customers;
a system for confirming resolution of the problems and incidents reported;
a system for closing said problems and incidents; and
at least one service desk repository for storing information useful in solving problems and incidents, said repository accessible by the computer network.

65. The service desk of claim 64, wherein the system for solving problems further comprises at least one tool selected from the group consisting of number identification service, automatic number identification, automatic call distribution, a voice response unit, computer telephone integration, expert systems, knowledge tools, an automatic logging tool, an automatic tracking tool, an automatic reporting tool, and a web-enabled service desk tool.

66. The service desk of claim 64, wherein the service desk further comprises a system for gathering at least one datum selected from the group consisting of service level agreement compliance, first pass resolution, first call resolution, call abandonment rate, call wait time, Tier 1 resolution rate, Tier 2 resolution rate, Tier 3 resolution rate, number of open requests, number of logged requests and solved requests, number of complaints, volunteered comments and customer surveys.

67. The service desk of claim 64 wherein the problems and incidents are selected from the group consisting of information technology, human resources, finance, engineering, medicine, nursing, procedure, insurance, retail, and legal resources.
